(19) United States
(12) Patent Application Publication
(10) Pub. No.: US 2019/0096009 A1
(43) Pub. Date: Mar. 28, 2019

(54) DATA PROCESSING METHOD, APPARATUS AND SYSTEM FOR GAS STATION

(71) Applicant: Alibaba Group Holding Limited, Grand Cayman (KY)

(72) Inventors: Siqi Xu, Hangzhou (CN); Yiqing Xie, Hangzhou (CN)

(21) Appl. No.: 16/141,810

(22) Filed: Sep. 25, 2018

(30) Foreign Application Priority Data
Sep. 26, 2017 (CN) 201710884248.2

(51) Int. Cl. G06Q 50/06; G06F 17/30; G06Q 30/02; G06Q 20/18; B25J 11/00

(52) U.S. Cl. CPC G06Q 50/06; G06F 17/30876; G06Q 30/0259; B25J 11/005; G06Q 30/0244; G06Q 20/18; G06Q 30/0201

(57) ABSTRACT

A system including a service terminal of a network account subsystem, an image acquisition subsystem and an oil machine subsystem. The service terminal of the network account subsystem provides an association relation between user payment account information and vehicle identifier information. The image acquisition subsystem acquires an image of a vehicle that enters the gas station for refueling, and identifies vehicle identifier information according to an image acquisition result. The oil machine subsystem, after obtaining resource information to be paid for refueling, provides the identified vehicle identifier information and the resource information to the service terminal of the network account subsystem. The service terminal of the network account subsystem further determines associated user payment account information according to the vehicle identifier information and generates a refueling transaction order based on the resource information to be paid. The efficiency of payment for refueling is improved.

### CROSS REFERENCE TO RELATED PATENT APPLICATIONS

This application claims priority to and is a continuation of Chinese Patent Application No. 201710884248.2 filed on Sep. 26, 2017 and entitled “DATA PROCESSING METHOD, APPARATUS AND SYSTEM FOR GAS STATION”, which is incorporated herein by reference in its entirety.

### TECHNICAL FIELD

The present disclosure relates to the field of gas station system information processing technologies, and, more particularly, to data processing methods, apparatuses and systems for a gas station.

### BACKGROUND

A gas station refers to a replenishment station that serves automobiles and other motor vehicles and retail sells gasoline and engine oil. The gas station generally provides fuel oil, lubricating oil, and the like. Oil products sold at the gas station have features of being flammable, explosive and volatile, and are prone to leakage and static charge accumulation, and so on. Therefore, refueling services may be provided to users only in the form of offline physical gas stations. Unlike other types of merchandises, it is not likely to open online virtual stores and door-to-door deliver oil products to the users by logistics. Although refueling-related online virtual stores also exist in the conventional techniques, objects of sales are mainly refueling cards, including services of selling and recharging refueling cards.

However, in an overall environment where online and offline integration is a development trend, how to integrate the industry of gas stations into such environment so that users may enjoy more convenient and quicker refueling service experience has become a technical problem to be solved by those skilled in the art.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides data processing methods, apparatuses and systems for a gas station, which improve the efficiency of payment for refueling and lay a foundation for implementing online and offline integrated information services related to a gas station.

The present disclosure provides the following solutions:

A data processing system for a gas station, including:
an oil machine subsystem, a code scanning subsystem, and a service terminal of a network account subsystem;
the service terminal of the network account subsystem being configured to provide a client terminal with information of a graphic code carrying user payment account information, and generate a transaction order after receiving payment account information which is submitted by the code scanning subsystem through code scanning and resource information to be paid for refueling;
the code scanning subsystem being configured to scan the graphic code displayed by the client terminal of the network account subsystem after learning the resource information to be paid for refueling, and submit a code scanning result to the service terminal of the network account subsystem; and
the oil machine subsystem being configured to obtain the resource information to be paid for refueling and provide the resource information to the code scanning subsystem.

A data processing method for a gas station, including:
providing, by a service terminal of a network account subsystem, information of a graphic code carrying user payment account information to a client terminal, so that the graphic code is displayed to a code scanning subsystem through the client terminal; and
generating a transaction order after receiving resource information to be paid for refueling provided by the code scanning subsystem and payment account information which is submitted by the code scanning subsystem through scanning the graphic code.

A data processing method for a gas station, including:
receiving, by a code scanning subsystem, resource information to be paid for refueling provided by an oil machine subsystem;
scanning a graphic code displayed by a client terminal of a network account subsystem, the graphic code carrying user payment account information; and
providing a service terminal of the network account subsystem with the code scanning result and the resource information to be paid, so that the service terminal of the network account subsystem generates a transaction order.

A data processing method for a gas station, including:
obtaining, by an oil machine subsystem, resource information to be paid for refueling, and providing the resource information to a code scanning subsystem;
requesting to obtain payment confirmation information from a service terminal of a network account subsystem after a code scanning completion notification message provided by the code scanning subsystem is received, wherein a service terminal of the code scanning subsystem is configured to scan a graphic code carrying user payment account information that is provided by a client terminal of the network account subsystem, and provide the service terminal of the network account subsystem with the resource information to be paid, so that the service terminal of the network account subsystem generates a transaction order; and
providing payment success information to the code scanning subsystem after the payment success information is obtained from the service terminal of the network account subsystem.

A data processing system for a gas station, including:
a service terminal of a network account subsystem, an image acquisition subsystem and an oil machine subsystem;
the service terminal of the network account subsystem being configured to provide an association relation between user payment account information and vehicle identifier information;
the image acquisition subsystem being configured to acquire an image of a vehicle that enters the gas station for refueling, and identify vehicle identifier information according to an image acquisition result;
the oil machine subsystem being configured to obtain resource information to be paid for refueling and provide the identified vehicle identifier information and the resource information to the service terminal of the network account subsystem; and
the service terminal of the network account subsystem being further configured to determine associated user payment account information according to the vehicle identifier information and generate a refueling transaction order based on the resource information to be paid.

A data processing method for a gas station, including:
providing, by a service terminal of a network account subsystem, an association relation between user payment account information and vehicle identifier information;
receiving identifier information of a vehicle that enters the gas station for refueling and resource information to be paid that are submitted by an oil machine subsystem; and
determining associated payment account information according to the identifier information of the vehicle, and generating a transaction order according to the payment account information and the resource information.

A data processing method for a gas station, including:
obtaining, by an oil machine system, identifier information of a vehicle that enters the gas station for refueling from an image acquisition subsystem; and
determining resource information to be paid for refueling, and then providing the identified identifier information of the vehicle and the resource information to a service terminal of a network account subsystem, so that the service terminal of the network account subsystem determines associated user payment account information according to the identifier information of the vehicle and generates a refueling transaction order based on the resource information to be paid.

An information processing method for a gas station, including:
providing in a user interface, by a client terminal of a network account subsystem, an operation option for configuring vehicle identifier information, required oil product information, and required refueling quantity information; and
submitting specific configuration information received through the operation option to a service terminal of the network account subsystem, so that the service terminal stores the specific configuration information and provides the specific configuration information to an oil machine subsystem when a vehicle enters the gas station for refueling.

A gas station system, including:
an image acquisition subsystem configured to acquire an image of a vehicle that enters the gas station and identify a vehicle identifier of the vehicle; and
an oil machine subsystem configured to obtain resource information to be paid for refueling and provide information of the identified vehicle identifier and the resource information to a service terminal of a network account subsystem, so that the service terminal of the network account subsystem determines associated user payment account information according to the information of the vehicle identifier, and generates a refueling transaction order based on the resource information to be paid.

A data processing apparatus for a gas station, applied to a service terminal of a network account subsystem, including:
a graphic code information providing unit configured to provide a client terminal with information of a graphic code carrying user payment account information, so that the graphic code is displayed to a code scanning subsystem through the client terminal; and
a transaction order generation unit configured to generate a transaction order after receiving resource information to be paid for refueling provided by the code scanning subsystem and payment account information which is submitted by the code scanning subsystem through scanning the graphic code.

A data processing apparatus for a gas station, applied to a code scanning subsystem, including:
a resource information receiving unit configured to receive resource information to be paid for refueling provided by an oil machine subsystem;
a graphic code scanning unit configured to scan a graphic code displayed by a client terminal of a network account subsystem, the graphic code carrying user payment account information; and
a submitting unit configured to provide a service terminal of the network account subsystem with the code scanning result and the resource information to be paid, so that the service terminal of the network account subsystem generates a transaction order.

A data processing apparatus for a gas station, applied to an oil machine subsystem, including:
a resource information providing unit configured to obtain resource information to be paid for refueling and provide the resource information to a code scanning subsystem;
a payment confirmation unit configured to request to obtain payment confirmation information from a service terminal of a network account subsystem after receiving a code scanning completion notification message provided by the code scanning subsystem, wherein a service terminal of the code scanning subsystem is configured to scan a graphic code carrying user payment account information that is provided by a client terminal of the network account subsystem, and provide the service terminal of the network account subsystem with the resource information to be paid, so that the service terminal of the network account subsystem generates a transaction order; and
a payment information transfer unit configured to provide payment success information to the code scanning subsystem after obtaining the payment success information from the service terminal of the network account subsystem.

A data processing apparatus for a gas station, applied to a service terminal of a network account subsystem, including:
an association relation providing unit configured to provide an association relation between user payment account information and vehicle identifier information;
an information receiving unit configured to receive identifier information of a vehicle that enters the gas station for refueling and resource information to be paid that are submitted by an oil machine subsystem; and
an order generation unit configured to determine associated payment account information according to the vehicle identifier information, and generate a transaction order according to the payment account information and the resource information.

A data processing apparatus for a gas station, applied to an oil machine subsystem, including:
a vehicle identifier information obtaining unit configured to obtain identifier information of a vehicle that enters the gas station for refueling from an image acquisition subsystem; and
an information submitting unit configured to determine resource information to be paid for refueling, and then provide the identified identifier information of the vehicle and the resource information to a service terminal of a network account subsystem, so that the service terminal of the network account subsystem determines associated user payment account information according to the identifier information of the vehicle, and generates a refueling transaction order based on the resource information to be paid.

A data processing apparatus for a gas station, applied to a client terminal of a network account subsystem, including:
an operation option providing unit configured to provide, in a user interface, an operation option for configuring vehicle identifier information, required oil product information, and required refueling quantity information; and
a configuration information submitting unit configured to submit specific configuration information received through the operation option to a service terminal of the network account subsystem, so that the service terminal stores the specific configuration information and provides the specific configuration information to an oil machine subsystem when a vehicle enters the gas station for refueling.

A state information processing method for a gas station, including:
obtaining, by a service terminal of a network account subsystem, identifier information of vehicles that go into and out of the gas station from an oil machine subsystem of the gas station; and
conducting statistics on entering and leaving information of vehicles associated with the same gas station to obtain real-time busy or idle state information of the gas station.

A method for providing gas station information in an electronic map system, including:
receiving, by a client terminal of the electronic map system, a gas station search request; submitting the request to a service terminal of the electronic map system, so that the service terminal searches for a matched gas station according to geographical location information of a terminal device associated with the client terminal, and obtains real-time busy or idle state information of the matched gas station from a service terminal of a network account subsystem; and
providing, in an electronic map information interface, location information of the matched gas station on the map and the real-time busy or idle state information of the matched gas station according to a response returned by the service terminal.

A method for providing gas station information in an electronic map system, including:
receiving, by a service terminal of the electronic map system, a gas station search request from a client terminal;
searching for a matched gas station according to geographical location information of a terminal device associated with the client terminal, and obtaining real-time busy or idle state information of the matched gas station from a network account subsystem; and
returning location information of the matched gas station on the map and the real-time busy or idle state information of the matched gas station to the client terminal, so that the client terminal provides the location information and the real-time busy or idle state information in an electronic map information interface.

An information processing method for a gas station, including:
conducting statistics, by a service terminal of a network account subsystem, on gas-station-related transaction orders from a user dimension;
obtaining information about gas-station-related consumption habits of the same user; and
storing information about gas-station-related consumption habits of each user.

A method for pushing gas-station-related recommendation information, including:
obtaining, by an oil machine subsystem, identity information related to a user that enters a gas station for refueling;
obtaining information about gas-station-related consumption habits of the corresponding user from a service terminal of a network account subsystem by using the identity information related to the user; and
determining to-be-recommended data object information according to the information about gas-station-related consumption habits of the user and data object information associated with the gas station, and pushing the to-be-recommended data object information to the user.

A method for conducting statistics on information of a gas station, including:
conducting statistics, by a service terminal of a network account subsystem, on transaction orders related to gas stations from a gas station dimension;
obtaining user population distribution information associated with the same gas station; and
providing the user population distribution information to an oil machine subsystem, so that a data object structure of a store associated with the gas station is determined or adjusted according to the user population distribution information.

According to specific embodiments provided in the present disclosure, the present disclosure achieves the following technical effects:

Through the embodiments of the present disclosure, upgrading of a data processing system for an entire gas station is realized with the intervention of a network account subsystem, so that users enjoy more convenient and quicker refueling payment experience; moreover, a foundation for implementing information services related to a gas station is laid.

A variety of related information services may be provided. For example, users may obtain accurate pushing of related state information about a gas station or commodity information. In addition, statistics information about population features and vehicle features may also be provided for the gas station. Moreover, related statistics information may also be provided for associated stores, thus helping the stores to adjust product structures, enhance the service capability, and so on.

Certainly, implementation of any product of the present disclosure does not need to achieve all the advantages described above at the same time.

### BRIEF DESCRIPTION OF THE DRAWINGS

To illustrate the technical solutions according to the embodiments of the present disclosure more clearly, the accompanying drawings for describing the embodiments are introduced briefly in the following. It is apparent that the accompanying drawings in the following description only represent some embodiments of the present disclosure. Those of ordinary skill in the art may obtain other drawings according to the accompanying drawings without creative efforts.

FIG. 1 is a schematic diagram of a first system according to an embodiment of the present disclosure;

FIG. 2 is a flowchart of a first method according to an embodiment of the present disclosure;

FIG. 3 is a flowchart of a second method according to an embodiment of the present disclosure;

FIG. 4 is a flowchart of a third method according to an embodiment of the present disclosure;

FIG. 5 is a schematic diagram of a second system according to an embodiment of the present disclosure;

FIG. 6 is a flowchart of a fourth method according to an embodiment of the present disclosure;

FIG. 7 is a flowchart of a fifth method according to an embodiment of the present disclosure;

FIG. 8 is a flowchart of a sixth method according to an embodiment of the present disclosure;

FIG. 9 is a flowchart of a seventh method according to an embodiment of the present disclosure;

FIG. 10 is a flowchart of an eighth method according to an embodiment of the present disclosure;

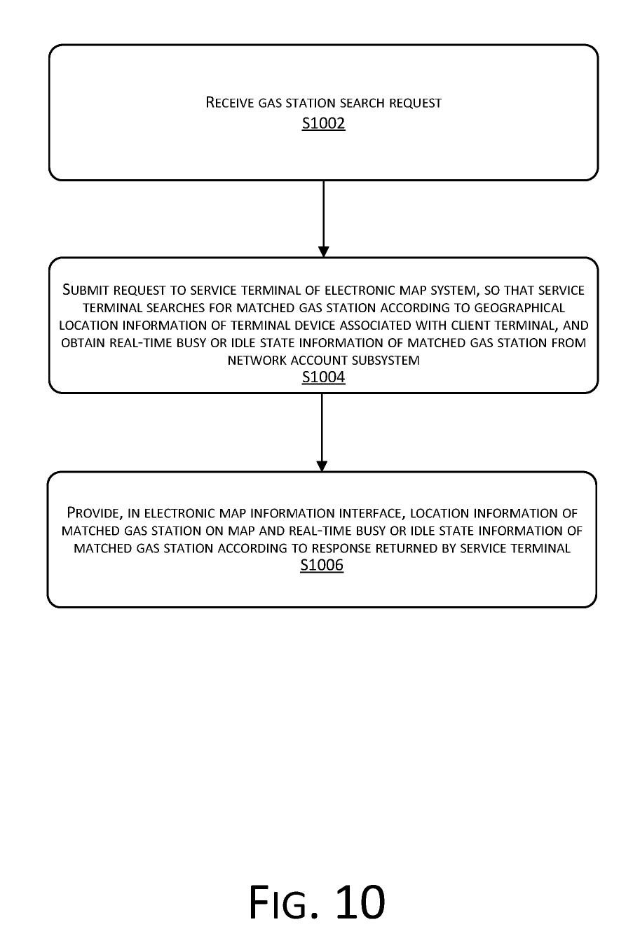

FIG. 11 is a flowchart of a ninth method according to an embodiment of the present disclosure;

FIG. 12 is a flowchart of a tenth method according to an embodiment of the present disclosure;

FIG. 13 is a flowchart of an eleventh method according to an embodiment of the present disclosure;

FIG. 14 is a flowchart of a twelfth method according to an embodiment of the present disclosure;

FIG. 15 is a schematic diagram of a first apparatus according to an embodiment of the present disclosure;

FIG. 16 is a schematic diagram of a second apparatus according to an embodiment of the present disclosure;

FIG. 17 is a schematic diagram of a third apparatus according to an embodiment of the present disclosure;

FIG. 18 is a schematic diagram of a fourth apparatus according to an embodiment of the present disclosure;

FIG. 19 is a schematic diagram of a fifth apparatus according to an embodiment of the present disclosure;

FIG. 20 is a schematic diagram of a sixth apparatus according to an embodiment of the present disclosure;

FIG. 21 is a schematic diagram of a seventh apparatus according to an embodiment of the present disclosure;

FIG. 22 is a schematic diagram of an eighth apparatus according to an embodiment of the present disclosure;

FIG. 23 is a schematic diagram of a ninth apparatus according to an embodiment of the present disclosure;

FIG. 24 is a schematic diagram of a tenth apparatus according to an embodiment of the present disclosure;

FIG. 25 is a schematic diagram of an eleventh apparatus according to an embodiment of the present disclosure; and

FIG. 26 is a schematic diagram of a twelfth apparatus according to an embodiment of the present disclosure.

### DETAILED DESCRIPTION

The technical solutions in the embodiments of the present disclosure will be clearly and fully described below with reference to the accompanying drawings in the embodiments of the present disclosure. It is obvious that the embodiments to be described only represent a part rather than all of the embodiments of the present disclosure. All other embodiments derived by those of ordinary skill in the art based on the embodiments of the present disclosure without creative efforts should fall within the protection scope of the present disclosure.

In the embodiments of the present disclosure, first of all, a processing procedure of a gas station may be improved in terms of a payment manner. For example, in the conventional techniques, in the process of refueling at a gas station, a user needs to inform an oil supplier of information such as a required oil product (an oil number, for example, No. 92 gasoline, No. 95 gasoline, or the like) and the quantity (fill to the full or spend a certain amount of money for oil), and then the user needs to give cash to the oil supplier or to a designated cashier. Alternatively, in the case where a refueling card is purchased in advance, the user may also use the refueling card to make payment.

In the embodiments of the present disclosure, rapid payment may be realized through an account registered by a user in a network account subsystem, and the user does not need to get off the car or buy a refueling card in advance. In a specific implementation manner, there may be two specific implementation solutions. In one solution, an oil supplier in a gas station may be equipped with a handheld code scanning subsystem (which may be referred to as a payment terminal such as a “POS machine” in some scenarios). Preset software may be installed in the handheld code scanning subsystem, so that a code scanning function may be implemented. As such, upon completion of refueling, the code scanning subsystem may first obtain resource quantity (amount of money, etc.) information to be paid. Moreover, the user may open a client terminal of a specific network account subsystem installed on his/her terminal device, such as “Taobao™ mobile”, “Tmall” and “Alipay™ ”, and open a graphic code page for payment to show the graphic code page to an oil supplier. The oil supplier may scan the graphic code of the user by using the code scanning subsystem, so that a service terminal of the network account subsystem such as Taobao™ mobile may create a corresponding order. Payment for the order may be made subsequently by using an associated payment subsystem (for example, an “Alipay™” system or the like, which certainly may also be another payment system, for example, a banking system and so on).

Funds data is involved in an actual application. Therefore, in order to ensure the security of information and avoid the loss of a gas station, interaction between a network account subsystem and a code scanning subsystem may also be transferred by using an oil machine Enterprise Resource Planning (ERP) system (the system is a system managed by the gas station itself and may be referred to as an “oil machine subsystem” in the embodiments of the present disclosure). Moreover, it may also be required that another code provider other than the network account subsystem provides a code scanning subsystem and develops software in the code scanning subsystem. As such, all specific transaction procedures may be sensed by the oil machine subsystem.

Based on the above considerations, the embodiments of the present disclosure may define a data processing procedure among an existing oil machine subsystem, an application program in a code scanning subsystem, and a server of a network account subsystem.

First of all, the foregoing technical solutions provided in the embodiments of the present disclosure are introduced in detail in the following.

### EMBODIMENT 1

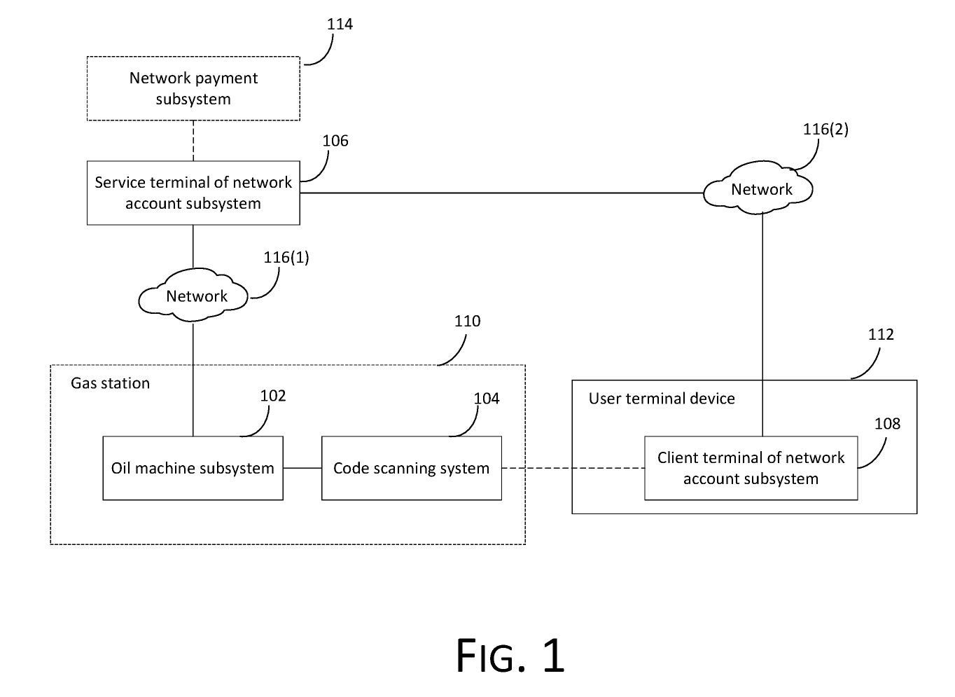

First of all, Embodiment 1 provides a data processing system for a gas station from the perspective of a payment manner. The system mainly makes payment through code scanning by a code scanning subsystem. For example, referring to FIG. 1, the system may include an oil machine subsystem 102, a code scanning subsystem 104, and a service terminal of a network account subsystem 106. The oil machine subsystem 102 and the code scanning system 104 are located at a gas station 110.

The service terminal of the network account subsystem 106 is configured to provide a client terminal 108 at a user terminal device 112 with information of a graphic code carrying user payment account information, and generate a transaction order after receiving payment account information which is submitted by the code scanning subsystem 104 through code scanning and resource information to be paid for refueling.

The service terminal of the network account subsystem 106 may retrieve payment information from the network payment subsystem 114 according to the payment account information.

The code scanning subsystem 104 is configured to scan a graphic code displayed by the client terminal 108 of the network account subsystem after learning the resource information to be paid for refueling, and submit a code scanning result to the service terminal of the network account subsystem 106.

The oil machine subsystem 102 is configured to obtain the resource information to be paid for refueling and provide the resource information to the code scanning subsystem 104.

The service terminal of the network account subsystem 106, the oil machine subsystem 102, and the client terminal of the network account subsystem 108 may be connected via one or more networks 116(1) or 116(2). The networks 116(1) and 116(2) may be a wireless network.

For example, after an oil machine completes a refueling operation on a specific vehicle and hangs up an oil gun, the oil machine subsystem may obtain an identifier of a specific gas station, information about an oil product filled, refueling quantity information, and corresponding resource information (refueling card, amount of money, or the like) to be paid. In this case, the oil machine subsystem may provide the above information to the code scanning subsystem. The code scanning subsystem may obtain information such as an account of the user in the network account subsystem after scanning a graphic code shown by the user. Then, the code scanning subsystem may submit the information obtained from the oil machine and the user account information obtained through code scanning to the server of the network account subsystem and notify the oil machine subsystem that the code scanning operation has been completed. Afterwards, the oil machine subsystem may send a request of confirming a specific payment condition to the server of the network account subsystem. The server of the network account subsystem may generate a transaction order after receiving the information submitted by the code scanning subsystem and may complete payment for the transaction order by using the payment subsystem. If the user signs a withholding agreement in advance in the payment subsystem, the payment for the order may be directly completed while the user does not need to input a password, or if the user does not sign any withholding agreement or the amount of the order is too high, the payment for the transaction order may be completed after the user inputs a password (including inputting specific password characters, inputting a fingerprint, and many other manners). After receiving an order confirmation request from the oil machine subsystem, the service terminal of the network account subsystem may provide the oil machine subsystem with the information indicating that the corresponding order has been paid for. Then, the oil machine subsystem may provide the code scanning subsystem with the information indicating that the corresponding order has been paid for. As such, the oil supplier may know, by using the code scanning subsystem, information indicating that the payment has been completed, and release the corresponding vehicle.

In other words, in a specific implementation manner, when transferring information, the oil machine subsystem may be, for example, configured to: first of all, obtain resource information to be paid for refueling after the oil gun of the gas station is hung up (which represents that refueling for a vehicle has been completed), then provide the resource information to the code scanning subsystem, request to obtain payment confirmation information from the network account subsystem after receiving a code scanning completion notification message provided by the code scanning subsystem, obtain payment success information, and then provide the payment success information to the code scanning subsystem, to serve as a basis for releasing the vehicle.

It should be noted that as the information submitted by the code scanning subsystem to the service terminal of the network account subsystem may include specific oil product information, quantity information, resource information and so on, the above information may also be embodied in the order generated in the service terminal of the network account subsystem. As such, the user may query specific order details in the service terminal of the network account subsystem. That is, although refueling is carried out in an offline gas station, corresponding order details may be queried in the online service terminal of the network account subsystem. Certainly, in an actual application, if it is only intended to implement a fast payment function, it is unnecessary to provide oil product information, quantity information, gas station identifier information and the like to the service terminal of the network account subsystem. In this case, the service terminal of the network account subsystem may create an “order without goods” and complete payment. In addition, an invoice issuing operation option may also be provided based on the order created in the service terminal of the network account subsystem. The user may submit a request for issuing an invoice in an online manner and obtain an electronic invoice. As such, the user may make payment, obtain an invoice and the like in the entire refueling process without getting off the car, thus saving his/her time cost.

In addition, in an actual application, there may be multiple vehicles refueled in one gas station at the same time. Therefore, a corresponding relationship between user payment accounts and vehicle identifier information may be stored in the service terminal of the network account subsystem in advance (information of the corresponding relationship may be configured by the user in the network account subsystem in advance), so as to make it easy to know a specific vehicle corresponding to which the payment operation has been completed. In this case, when providing payment success information to the oil machine subsystem, the service terminal of the network account subsystem may further provide associated vehicle identifier information to the oil machine subsystem. As such, the oil machine subsystem may further provide the vehicle identifier information to the code scanning subsystem, and the oil supplier may know, by using the code scanning subsystem, the specific vehicle corresponding to which the payment has been made successfully, and release the vehicle corresponding to the specific vehicle identifier.

In addition, in an actual application, the information provided by the oil machine subsystem to the code scanning subsystem may further include gas station identifier information, identifier information of a filled oil product and/or quantity information of the filled oil product, and is provided to the network account subsystem by the code scanning subsystem. As such, when the network account subsystem generates a transaction order, the above information may be embodied in the transaction order, to facilitate the user to make query subsequently. In addition, the network account subsystem may further provide, in an interface of the order, an invoice issuing operation option to be used for issuing an electronic invoice online.

In addition, the graphic code shown by the user may be a common graphic code that carries user payment account information, or in an example implementation manner, a graphic code may also be provided for the user by means of Passport. The so-called Passport means that an account registered in the network account subsystem by the user may be merged with membership card information of various offline brands, in which membership card information of a specific gas station may be included. In a specific implementation manner, many member recruiting manners may be provided. For example, a “membership code” entry may be displayed at the upper right corner of the home page of “Taobao™ mobile”. After a user clicks to enter a specific “membership code” page, optional brands may be displayed at the bottom of the page. Optional brands nearby may be recommended, for example, according to the geographical location of the user, and so on. In addition, an option such as “join” may be further provided for the brands recommended, and the user may become a member of a specific brand by clicking the option. For example, in the embodiment of the present disclosure, a specific gas station may be recommended in the “membership code” page of the user and an operation option for joining as a member of the gas station may be provided. The user may become a member of the gas station through the operation option. Alternatively, in another implementation manner, the user may also become a member of a brand by scanning a graphic code in an offline store of the brand, and so on. In brief, in this manner, membership information of the brand that the user joins may be embodied in the graphic code provided by the network account subsystem. Moreover, the user may choose to join as members of multiple brands without maintaining multiple membership cards or membership codes respectively, thus implementing “all codes in one”. In addition, if an offline physical store of a brand provides some rights and interests for members, for example, a coupon of 30 yuan minus 10 yuan, or the like, such information may be stored as information corresponding to the membership code of the user. As such, the offline rights and interests may be canceled online after verification in the process that the user uses the membership code to make payment.

In other words, in a specific implementation manner, the graphic code may further carry membership information registered in the gas station by the corresponding user, that is, the graphic code may be in the form of a Passport membership code. As such, if the membership information is associated with information about consumer rights and interests, the network account subsystem may further cancel the consumer rights and interests after verification according to a condition corresponding to the information about consumer rights and interests when payment is made. For example, the network account subsystem may deduct, according to promotional information, from the resources to be paid, and so on.

### EMBODIMENT 2

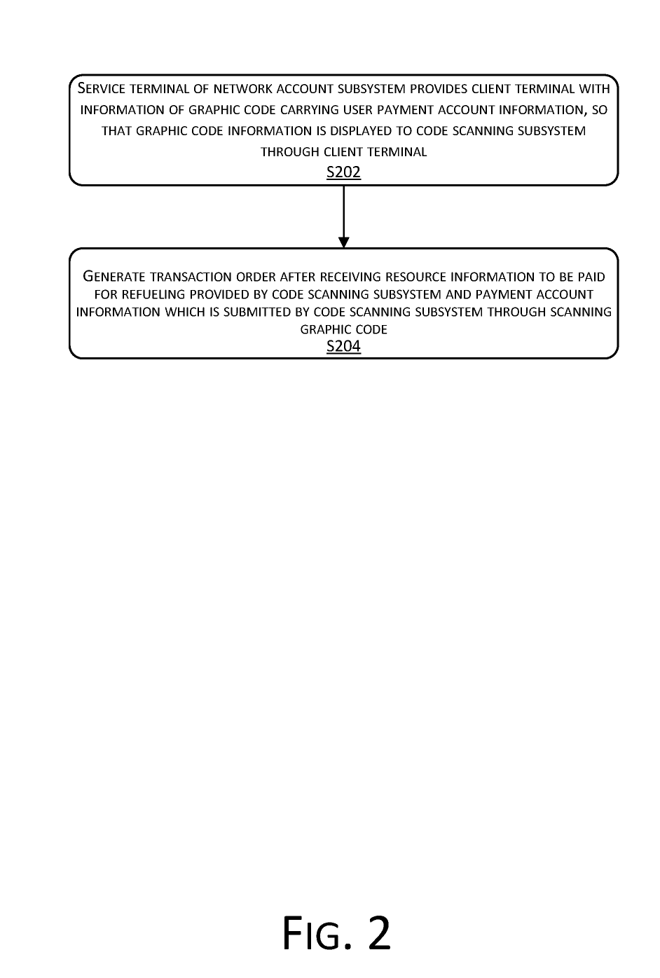

Embodiment 2 corresponds to Embodiment 1 and provides a data processing method for a gas station from the perspective of a service terminal of a network account subsystem. Referring to FIG. 2, the method may, for example, include the following steps:

S202: A service terminal of a network account subsystem provides a client terminal with information of a graphic code carrying user payment account information, so that the graphic code is displayed to a code scanning subsystem through the client terminal.

S204: A transaction order is generated after resource information to be paid for refueling provided by the code scanning subsystem and payment account information which is submitted by the code scanning subsystem through scanning the graphic code are received.

In a specific implementation manner, after the transaction order is generated, information of the transaction order may be further provided to an associated payment subsystem, so that the payment subsystem pays for the transaction order. After payment success information is obtained from the payment subsystem, the payment success information may be further provided to an oil machine subsystem, and the oil machine subsystem provides the payment success information to the code scanning subsystem.

In addition, the information submitted by the code scanning subsystem may further include gas station identifier information, identifier information of a filled oil product and/or quantity information of the filled oil product. As such, for example, when a transaction order is generated, the gas station identifier information, the identifier information of the filled oil product and/or the quantity information of the filled oil product may also be added to the transaction order. In addition, an invoice issuing operation option may be further provided in an interface of the order, to be used for issuing an electronic invoice online.

In a specific implementation manner, the service terminal of the network account subsystem may further pre-store a corresponding relationship between user payment accounts and vehicle identifier information. As such, when the payment success information is provided to the oil machine subsystem, information of an associated vehicle identifier may be further provided to the oil machine subsystem, so as to serve as a basis for releasing a vehicle corresponding to the vehicle identifier.

In a specific implementation manner, the graphic code may further carry membership information registered in the gas station by the corresponding user. As such, the membership information may be further associated with information about consumer rights and interests. Moreover, the consumer rights and interests may be further canceled after verification according to a condition corresponding to the information about the consumer rights and interests when the transaction order is generated.

### EMBODIMENT 3

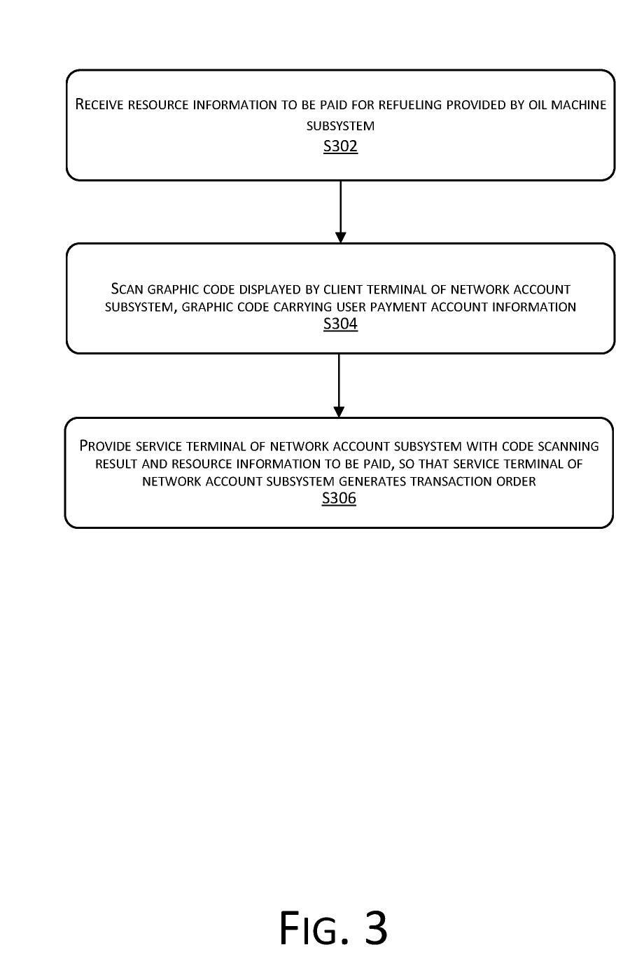

Embodiment 3 corresponds to Embodiment 1 and provides a data processing method for a gas station from the perspective of a code scanning subsystem. Referring to FIG. 3, the method may, for example, include the following steps:

S302: A code scanning subsystem receives resource information to be paid for refueling provided by an oil machine subsystem.

S304: A graphic code displayed by a client terminal of a network account subsystem is scanned, wherein the graphic code carries user payment account information.

S303: The code scanning result and the resource information to be paid are provided to a service terminal of the network account subsystem, so that the service terminal of the network account subsystem generates a transaction order.

### EMBODIMENT 4

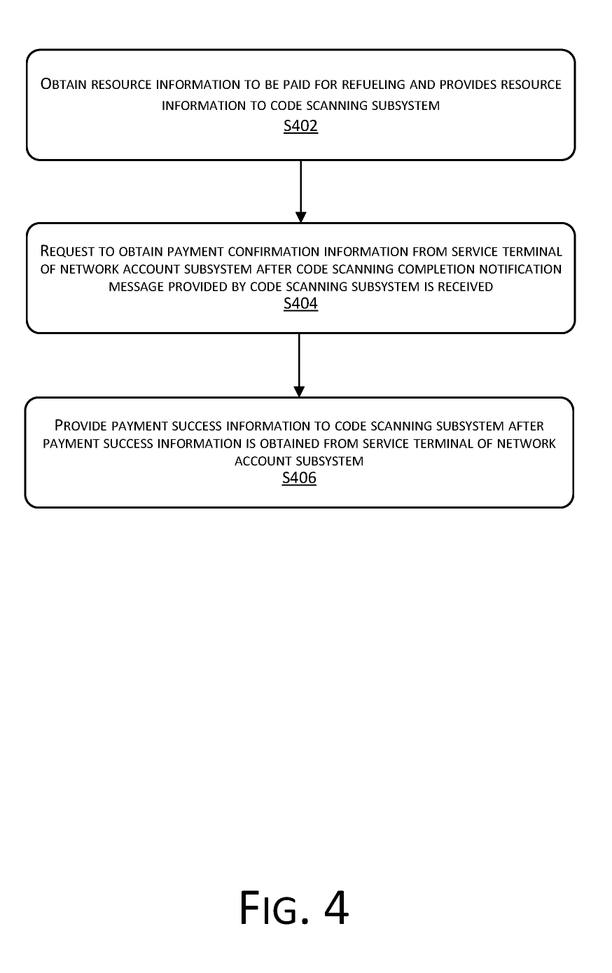

Embodiment 4 also corresponds to Embodiment 1 and provides a data processing method for a gas station from the perspective of an oil machine subsystem. Referring to FIG. 4, the method may, for example, include the following steps:

S402: An oil machine subsystem obtains resource information to be paid for refueling and provides the resource information to a code scanning subsystem.

S404: Payment confirmation information is requested from a service terminal of a network account subsystem after a code scanning completion notification message provided by the code scanning subsystem is received, wherein a service terminal of the code scanning subsystem is configured to scan a graphic code carrying user payment account information that is provided by a client terminal of the network account subsystem, and provide the service terminal of the network account subsystem with the resource information to be paid, so that the service terminal of the network account subsystem generates a transaction order.

S406: After payment success information is obtained from the service terminal of the network account subsystem, the payment success information is provided to the code scanning subsystem.

In a specific implementation manner, associated vehicle identifier information may be further obtained from the service terminal of the network account subsystem when payment success information is obtained from the service terminal of the network account subsystem, and the vehicle identifier information may be further provided to the code scanning subsystem when the payment success information is provided to the code scanning subsystem.

In the foregoing solution, the code scanning subsystem scans a code to implement payment. In another implementation manner, the payment may be more convenient and faster. In this manner, the user may bind his/her account information to associated vehicle identifier information (such as a license plate number) and the like in the network account subsystem in advance. In addition, a monitoring system may be further deployed in the gas station. As such, when the user drives a vehicle to enter the gas station, the monitoring system may acquire an image of identifier information such as the license plate number of the vehicle, identify the specific license plate number by using a technology such as OCR recognition, and provide the license plate number to the oil machine subsystem. In addition, upon completion of refueling, specific information such as a filled oil product, quantity and resources may also be provided to an ERP system. Then, the oil machine subsystem may submit information such as vehicle identifier information, oil product, quantity and resources together to the server of the network account subsystem. The server may first identify corresponding user account information according to the vehicle identifier information, generate a specific order according to the oil product, the quantity and the resources, complete payment, and provide payment completion information to the corresponding oil machine subsystem. It is thus clear that there is no need to perform code scanning and other procedures any more in this manner, and the payment may be more convenient and faster. This manner is described in detail in the following through Embodiment 5.

### EMBODIMENT 5

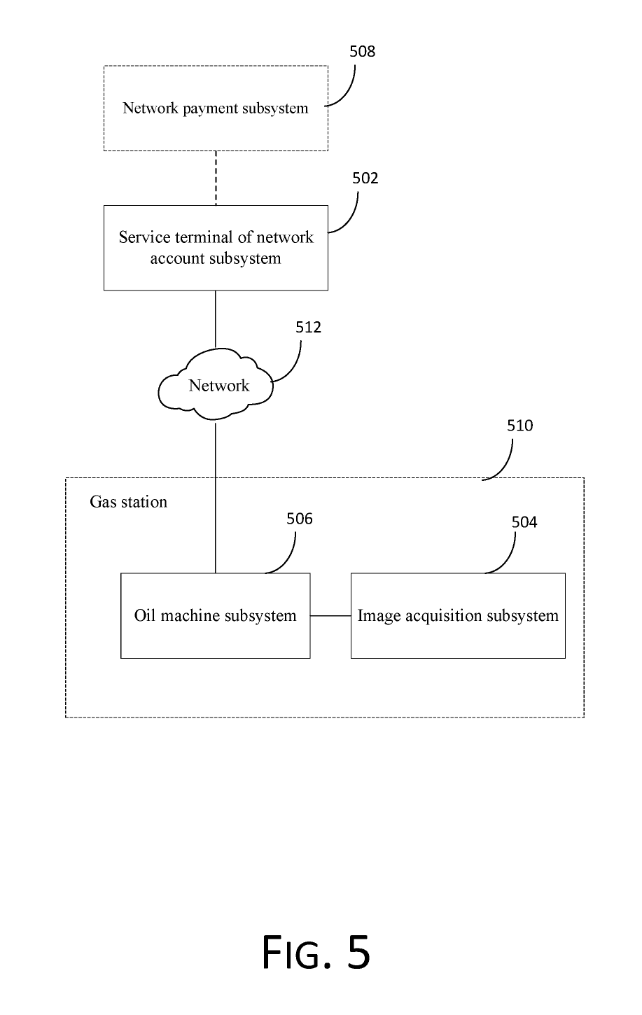

Embodiment 5 provides another payment system. In this system, a code scanning subsystem does not need to scan a code to make payment. Instead, vehicle identifier information may be bound to user payment account information in advance, and a monitoring system of a gas station may identify identifiers of vehicles that go into the gas station, thus making the payment more convenient. For example, Embodiment 5 of the present disclosure provides a data processing system for a gas station. Referring to FIG. 5, the system may, for example, include:
a service terminal of a network account subsystem 502, an image acquisition subsystem 504 and an oil machine subsystem 506.

The service terminal of the network account subsystem 502 is configured to provide an association relation between user payment account information and vehicle identifier information.

The image acquisition subsystem 504 is configured to acquire an image of a vehicle that enters the gas station for refueling, and identify vehicle identifier information according to an image acquisition result.

The oil machine subsystem 506 is configured to obtain resource information to be paid for refueling and provide the identified vehicle identifier information and the resource information to the service terminal of the network account subsystem.

The service terminal of the network account subsystem 502 is further configured to determine associated user payment account information according to the vehicle identifier information and generate a refueling transaction order based on the resource information to be paid.

The service terminal of the network account subsystem 502 may retrieve payment information from the network payment subsystem 508 according to the user payment account information.

The oil machine system 506 and the image acquisition subsystem 504 are located at the gas station 510.

The service terminal of the network account subsystem 502 and the oil machine subsystem may be connected via a network 512.

In a specific implementation manner, the information provided by the oil machine subsystem to the service terminal of the network account subsystem may further include gas station identifier information, identifier information of a filled oil product and/or quantity information of the filled oil product, so that such information is added to the refueling transaction order.

In the above manner, the user may inform the oil supplier of the specific oil product, quantity and the like required for refueling. Then, the oil supplier performs a specific refueling operation. Related data is automatically provided to the oil machine subsystem after the oil supplier hangs up the oil gun. Alternatively, in another manner, when account information of the user in the network account subsystem is bound to vehicle identifier information, specific oil product information may also be bound. In addition, specific quantity information required for refueling may also be set in the account of the user before the refueling is performed. As such, after a vehicle enters the gas station and a specific vehicle identifier is identified through the monitoring system, the oil machine subsystem may further provide information of the identifier to the network account subsystem first. The network account subsystem may provide the information such as a required oil product and quantity associated with the vehicle identifier to the oil machine subsystem. The oil machine subsystem may provide the corresponding information to the oil supplier through a preset display screen or by means of voice broadcast or the like, so that the oil supplier may refuel the vehicle.

In other words, in an example implementation manner, the service terminal of the network account subsystem may also be configured to provide required oil product and quantity information (which may be configured by the user in the network account subsystem in advance before the user enters the gas station, wherein the quantity information may be designated through information such as “full” or the amount of money for refueling). In this case, the oil machine subsystem may be further configured to: obtain, after acquiring identifier information of a vehicle that enters the gas station for refueling, required oil product and quantity information from the network account subsystem according to the identifier information of the vehicle.

The above information acquired by the oil machine subsystem enables the oil supplier to know specific oil product and quantity information required for refueling without asking the user. In a specific implementation manner, a display screen may be further deployed in the gas station. As such, the oil machine subsystem may be further configured to: output the required oil product and quantity information obtained from the network account subsystem to the display screen for display. As such, the oil supplier may view the specific oil product and quantity information required for refueling on the display screen, and then may carry out refueling by operating the oil gun and the oil machine.

Alternatively, in another more intelligent scenario, a mechanical arm for refueling may be further deployed in the gas station, and the mechanical arm is provided with a controller. Manual refueling operations of the oil supplier may be replaced with the mechanical arm to realize automatic refueling operations, and thus manual refueling of the oil supplier is replaced. In this case, the oil machine subsystem may be further configured to: output the required oil product and quantity information obtained from the network account subsystem to the controller of the mechanical arm, so that the controller of the mechanical arm controls the mechanical arm to complete a refueling process.

In addition, in a specific implementation manner, fuel tank caps of vehicles of different brands and different models may be at different locations, opening manners of the fuel tank caps may also vary. In order to facilitate the mechanical arm to find the locations of the fuel tank caps more accurately and open the fuel tank caps smoothly, information such as specific vehicle brands and models, the locations of the fuel tank caps, and the opening manners of the fuel tank caps may be further bound at the service terminal of the network account subsystem. The network account subsystem may be further configured to provide position and opening manner information of a fuel tank cap of a vehicle associated with a user payment account. Such information may also be configured by a user manually, and the network account subsystem may provide a corresponding configuration operation option in a user interface of the client terminal. Alternatively, after a user configures information such as a vehicle brand and model, the position and opening manner information of the corresponding fuel tank cap may be determined through a pre-stored database, and so on. As such, the network account subsystem may be further configured to provide the position and opening manner information of the fuel tank cap when providing required oil product and quantity information to the oil machine subsystem. Correspondingly, the oil machine subsystem may be further configured to: provide the position and opening manner information of the fuel tank cap obtained from the service terminal of the network account subsystem to the controller of the mechanical arm, so that the controller generates a corresponding operation instruction, and the mechanical arm completes operations to position and open the fuel tank cap. Expressions of the information of the location of the fuel tank cap and the opening manner information of the fuel tank cap may be described in advance in a standardized way, and a corresponding option is provided for the user. The user may set information of his/her vehicle by selecting a specific standardized description. As such, it may be easy for the controller of the mechanical arm to convert the information into a specific operation instruction.

### EMBODIMENT 6

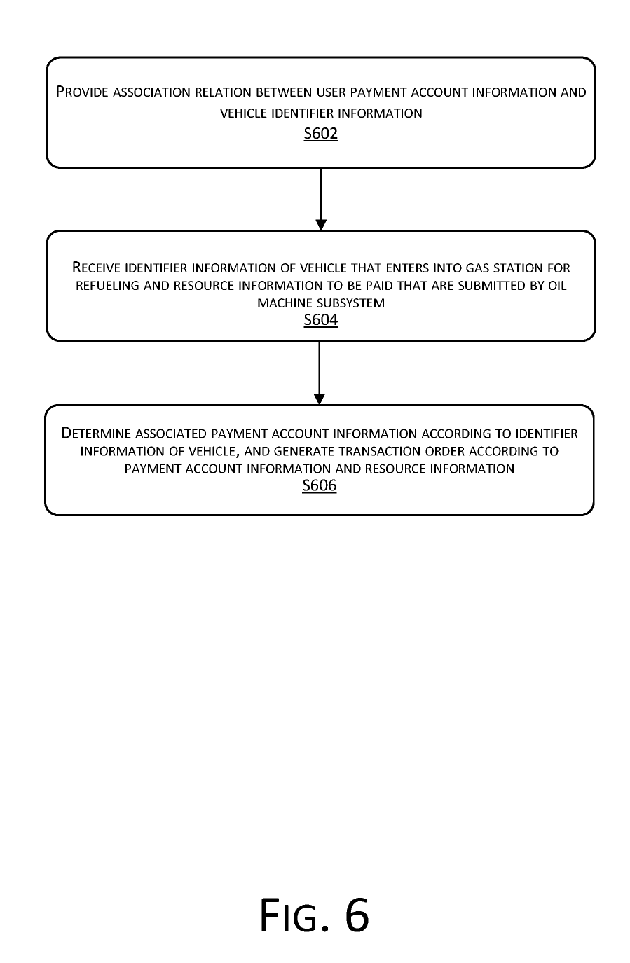

Embodiment 6 corresponds to Embodiment 5 and provides a data processing method for a gas station from the perspective of a service terminal of a network account subsystem. Referring to FIG. 6, the method may, for example, include the following steps:

S602: A service terminal of a network account subsystem provides an association relation between user payment account information and vehicle identifier information.

S604: Identifier information of a vehicle that enters the gas station for refueling and resource information to be paid that are submitted by an oil machine subsystem are received.

S606: Associated payment account information is determined according to the identifier information of the vehicle, and a transaction order is generated according to the payment account information and the resource information.

In a specific implementation manner, oil product and quantity information required by the associated vehicle may also be provided to the oil machine subsystem, so that the oil product and quantity information for refueling required by the user may be known without an inquiry to the user.

In addition, in the case where a mechanical arm is deployed in the gas station, position and opening manner information of a fuel tank cap of the associated vehicle may be further provided to the oil machine subsystem.

The existing gas station has been improved in terms of the payment manner as described above. As a specific payment process is associated with a network account subsystem, this also enables the network account subsystem to collect or conduct statistics on related information from multiple dimensions and provide multiple aspects of information services for users or the gas station side according to an information statistics result in combination with whole-network data in a network sales platform, so that the users and the gas station may obtain more abundant and more practical information.

For example, in one manner, statistics may be conducted on information from the dimension of busy or idle states of gas stations. For example, as the payment for a refueling process is made by using a network account subsystem, a server of the network account subsystem may sense busy or idle states of gas stations. For example, if order generation and payment operations are being performed for a certain vehicle in a certain gas station at a certain moment, the gas station is busy at this moment. Alternatively, as a monitoring system may be deployed in the gas station, after the monitoring system detects that a vehicle enters the gas station, the oil machine subsystem may further submit information about the vehicle that enters the gas station to the network account subsystem. As such, the network account subsystem may sense how many vehicles are in the same gas station at present and judge the busy or idle state of the gas station accordingly, and so on.

More comprehensive information may be provided by combining the busy or idle state information obtained by statistics with an electronic map search system. For example, if a user needs to search for nearby gas stations in an electronic map at a certain moment, in the embodiment of the present disclosure, nearby gas stations may be calculated according to the current location of the user and be marked on the electronic map; moreover, the electronic map system may further pull out the busy or idle state information of the gas stations from the network account subsystem. Moreover, busy or idle states of the gas stations may be marked while locations of the gas stations are marked in the electronic map system. In addition, different marking manners may also be provided according to different busy or idle degrees, and so on, so that the user may better choose a gas station for refueling.

In other words, in the embodiment of the present disclosure, the service terminal of the network account subsystem may further determine real-time busy or idle state information of a gas station according to identifier information of vehicles going into the corresponding gas station and states of all the vehicles that are provided by the oil machine subsystem. Then, busy or idle state information of gas stations may be requested from the network account subsystem when the electronic map system provides a gas station search result for the user. Correspondingly, the network account subsystem may provide the busy or idle state information of the gas stations to the electronic map system, and the electronic map system further provides the busy or idle state information of the gas stations when providing the gas station search result, thus helping the user better choose a gas station for refueling.

In addition, the oil machine subsystem may submit specific promotional information in the gas stations and the like to the service terminal of the network account subsystem. As such, the electronic map system may further pull out, from the service terminal of the network account subsystem, the promotional information associated with the gas stations which are included in the search result, and may further mark the specific promotional information when marking the locations of the gas stations. This may also help the user choose a gas station.

In addition, the service terminal of the network account subsystem may further provide the electronic map system with an operation entry for recharging a refueling card, so that the user of the refueling card may directly initiate a specific recharging operation in a user interface of the electronic map system.

In another manner, as it is necessary to use account information of the user in the network account subsystem when payment is made in the refueling process, information statistics may also be conducted from the perspective of the user. For example, each time payment is made, the oil machine subsystem may provide information such as an identifier of a specific gas station to the network account subsystem. Therefore, gas stations that a specific user usually goes to, oil products usually used for refueling, oil quantities and other information may be obtained through statistics. In addition, as an associated convenience store or the like is usually further deployed in a gas station, in the embodiment of the present disclosure, the user may also use account information in the network sales platform to make payment when shopping in the convenience store. As such, whether the user usually shops in convenience stores, categories of commodities usually purchased, and so on when the user enters the gas stations for refueling may be further obtained through statistics. Accordingly, related user portrait data may be provided for a user portrait platform from the dimension correlated with vehicle refueling, thus obtaining a more accurate user portrait result.

The foregoing user portrait data may be further used to push information more accurately to the user that enters the gas station for refueling. For example, a WiFi probe device may be further deployed in the gas station. As such, when the user enters the gas station for refueling, as long as a WiFi function on a terminal device of the user is turned on, the probe device may determine a unique device identifier such as a MAC address of the terminal device, and the oil machine subsystem submits the unique device identifier to the network account subsystem. As such, the network account subsystem may acquire, according to user account information associated with the device identifier, related historical record information about the corresponding user that has been generated in the network account subsystem, including categories of commodities usually purchased by the user, purchasing power, credit information, and so on. In addition, the related historical record information may further include the user portrait data recorded in the user portrait data platform. Moreover, as the user account information may be further bound to information such as specific vehicle brands and models, a vehicle brand, a vehicle model and other information associated with a user may be further determined when it is detected that the user enters the gas station for refueling. Then, information may be recommended more accurately to the user according to information of related data objects (such as commodity objects) in a convenience store associated with the current gas station. If a user's vehicle is “BMW” and the user usually shops in convenience stores of gas stations, and all purchased commodities are related to the vehicle “BMW”, when it is detected that the user enters a gas station for refueling, “BMW”-related data pair information that the convenience store of the current gas station may provide may be recommended to the user, and so on.

In other words, statistics may be conducted according to transaction orders that are associated with the same user and related to consumption in gas stations, to obtain and store refueling consumption habit information. For example, when such information is used, a WiFi probe device may be deployed in the gas station. Then, identifier information of a terminal device associated with a user that enters the gas station for refueling may be identified by using the WiFi probe device. Associated user account information is determined according to the identifier of the terminal device, and refueling consumption habit information of the user is obtained by using the user account information. Data object recommendation information is recommended to the user according to the refueling consumption habit information and a data object list associated with the gas station.

In addition, the information obtained through statistics by the network account subsystem in the process of paying for refueling may be further used to improve a service system of the gas station in addition to providing more abundant and more practical services for the user.

For example, in an actual application, a gas station is generally associated with a specific convenience store. In a conventional solution, a product structure or the like in the convenience store is generally managed in a standardized manner. That is, convenience stores of different gas stations have the same product structure. Alternatively, the product structure is slightly adjusted at most according to human experience or the like. For example, some goods with local characteristics are added to some convenience stores, and so on. In the embodiment of the present disclosure, the network account subsystem may further conduct statistics on features of a population going into the gas station for refueling from the dimension of gas station, for example, an age group to which most users belong, educational backgrounds and occupations of most users, and so on. In addition, brands, grades, the number of vehicles coming to a gas station for refueling every day, and so on may also be obtained through statistics. The above information may be provided to the oil machine subsystem, and the convenience store of the gas station may adjust or optimize the product structure according to the above information.

In other words, statistics may also be conducted on population distribution information and/or vehicle feature information of the same gas station according to transaction orders associated with an identifier of the same gas station, so as to determine or adjust a data object structure in a store associated with the gas station.

In addition, some improvements in other aspects may also be made for the convenience store. For example, the convenience store may be provided with a large smart screen on which some online products may be displayed, so that users going into the convenience store not only may choose and buy offline products in the convenience store but also may choose and buy online products by using the large smart screen. As such, online and offline commodities may complement each other. In addition, electronic labels may also be provided for specific commodities in the convenience store. By replacing the conventional paper labels with electronic labels, one-key management of the labels may be realized, and the efficiency may be improved. A self-service settlement device is provided in the convenience store, enabling users to complete self-service settlement and improving the payment efficiency for consumers. Moreover, the payment in the convenience store may also be made in a manner of Passport code scanning, so that offline transactions may be recorded in the network account subsystem, realizing statistics on user behaviors. Through a Passport membership code, consumer rights and interests obtained offline may also be canceled online after verification, and so on. In terms of the environment of the convenience store, an intelligent group control and Internet of Things linkage system may also be deployed in the convenience store to intelligently manage the temperature, humidity, lighting, and the like in the convenience store, and carry out intelligent sensing and adjustment for the consumers' physical sense.

In conclusion, in the embodiment of the present disclosure, comprehensive upgrade and transformation of the entire gas station system may be realized through the intervention of the network account subsystem, so that users may obtain more convenient and faster refueling payment experience and obtain push of related state information or product information about the gas station from other aspects. In addition, related statistical information may also be provided for an associated convenience store to help the convenience store adjust the product structure, enhance the service capability, and so on.

### EMBODIMENT 7

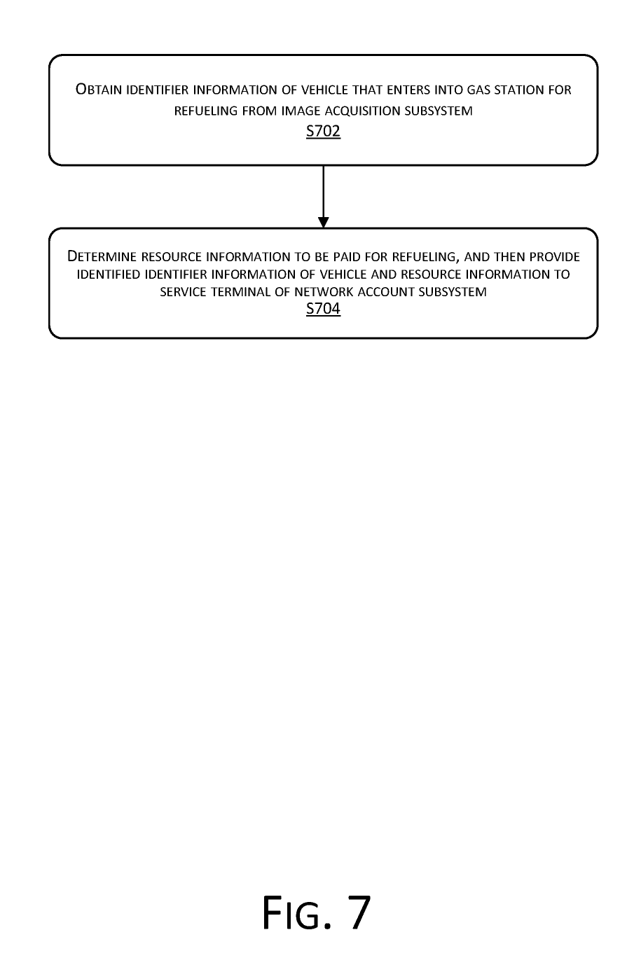

Embodiment 7 also corresponds to Embodiment 5 and provides a data processing method for a gas station from the perspective of an oil machine subsystem. Referring to FIG. 7, the method may, for example, include the following steps:

S702: An oil machine system obtains identifier information of a vehicle that enters the gas station for refueling from an image acquisition subsystem.

S704: Resource information to be paid for refueling is determined, and the identified identifier information of the vehicle and the resource information are provided to a network account subsystem, so that the network account subsystem determines associated user payment account information according to the identifier information of the vehicle, generates a refueling transaction order based on the resource information to be paid, and makes payment.

In a specific implementation manner, the information about oil product as well as quantity required for refueling may also be obtained from the network account subsystem, and may be output to a display screen for display, or provided to a controller of a mechanical arm to achieve automatic refueling.

For example, if a display screen is further deployed in the gas station, the required oil product and quantity information obtained from the network account subsystem may be output to the display screen deployed in the gas station for display. If the gas station further includes a mechanical arm for refueling, the mechanical arm being provided with a controller, the required oil product and quantity information obtained from the network account subsystem may be output to the controller of the mechanical arm, so that the controller of the mechanical arm controls the mechanical arm to complete a refueling process. In addition, position and opening manner information of a fuel tank cap obtained from the network account subsystem may be provided to the controller of the mechanical arm, so that the controller generates a corresponding operation instruction, and the mechanical arm completes operations to position and open the fuel tank cap.

### EMBODIMENT 8

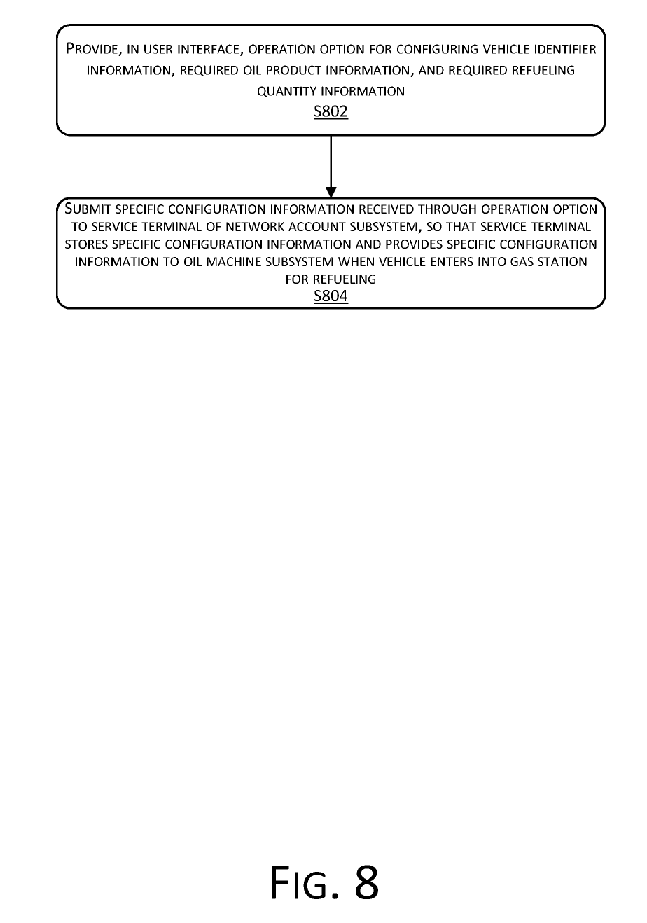

Embodiment 8 provides an information processing method for a gas station mainly from the perspective of a client terminal of a network account subsystem. That is, a specific consumer user may perform operations in some aspects such as configuration by using the client terminal. For example, referring to FIG. 8, the method may, for example, include the following steps:

S802: A client terminal of a network account subsystem provides, in a user interface, an operation option for configuring vehicle identifier information, required oil product information, and required refueling quantity information.

S804: The client terminal of the network account subsystem submits specific configuration information received through the operation option to a service terminal of the network account subsystem, so that the service terminal stores the specific configuration information and provides the specific configuration information to an oil machine subsystem when a vehicle enters the gas station for refueling.

In addition, an operation option for configuring position information and opening manner information of a fuel tank cap of the vehicle may be further provided. Specific configuration information about the fuel tank cap received through the operation option is submitted to the service terminal of the network account subsystem, so that the service terminal stores the specific configuration information and provides the specific configuration information to the oil machine subsystem when the vehicle enters the gas station for refueling, and the oil machine subsystem provides the specific configuration information of the fuel tank cap to a controller of a mechanical arm of an oil machine.

Multiple optional pieces of position information and multiple optional opening manners of fuel tank caps may be provided according to pre-generated standard description information of positions and opening manners, so that a specific piece of position information and a specific opening manner are selected therefrom to facilitate the controller of the mechanical arm to generate a control instruction.

### EMBODIMENT 9

Embodiment 9 mainly provides a gas station system. For example, the gas station system may include:
an image acquisition subsystem configured to acquire an image of a vehicle that enters the gas station and identify a vehicle identifier of the vehicle; and
an oil machine subsystem configured to obtain resource information to be paid for refueling and provide information of the identified vehicle identifier and the resource information to a service terminal of a network account subsystem, so that the service terminal of the network account subsystem determines associated user payment account information according to the information of the vehicle identifier, and generates a refueling transaction order based on the resource information to be paid.

In a specific implementation manner, a mechanical arm may be further deployed in the gas station to achieve automatic refueling. In addition, a display screen may also be deployed in the gas station to display required oil product and quantity information for refueling. The information may be provided to an oil supplier for viewing, and may also be provided to users for information confirmation.

In addition, a WiFi probe device may also be deployed in the gas station to identify an identifier of a terminal device associated with a user that enters the gas station, thus further implementing accurate information push to the user, and so on.

Moreover, a store may also be deployed in the gas station. A self-service settlement device may be deployed in the store. Electronic tags are added to packages of data objects in the store, so as to realize the self-service settlement of users and improve the payment efficiency. A terminal device may also be deployed in the store. The terminal device is provided with a display screen configured to present information of online data objects associated with the store, and process an online transaction order in response to an operation of the user. As such, online and offline data objects may complement each other. In addition, an Internet of Things system may also be deployed in the store to automatically adjust ambient parameters (including lighting, temperature, humidity, and the like) in the store.

### EMBODIMENT 10

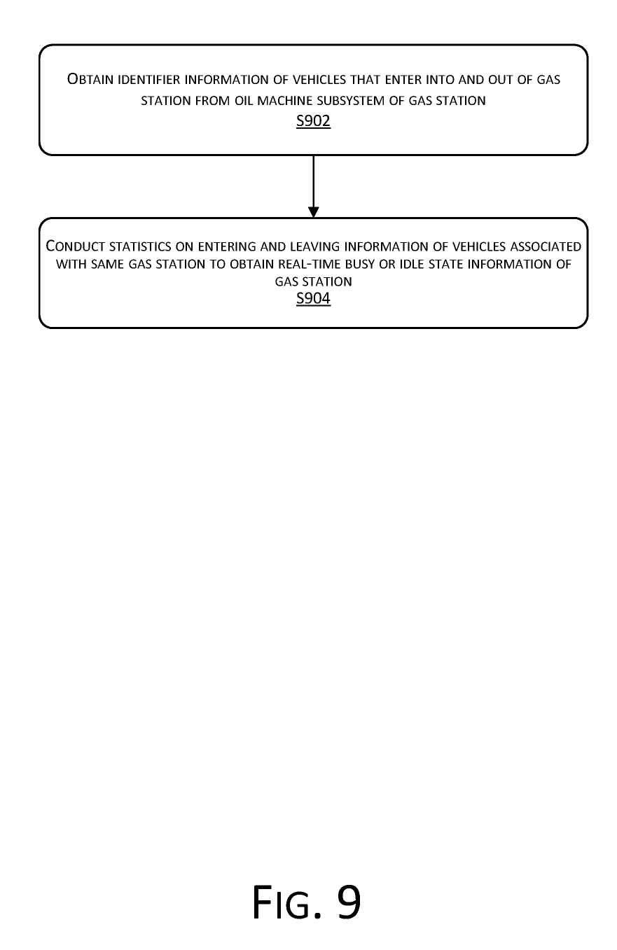

Embodiment 10 introduces one application (that is, conducting statistics on busy or idle states of gas stations and displaying the busy or idle states of the gas stations in an electronic map search result in real time) in specific information statistics applications. For example, Embodiment 8 provides a state information processing method for a gas station from the perspective of a service terminal of a network account subsystem. Referring to FIG. 9, the method may, for example, include the following steps:

S902: A service terminal of a network account subsystem obtains identifier information of vehicles that enter and out of the gas station from an oil machine subsystem of the gas station.

In a specific implementation manner, an image acquisition device may be deployed in the gas station. The image acquisition device is configured to acquire images of vehicles that go into and out of the gas station. Therefore, entering and leaving information of the vehicles in the gas station may be determined according to image acquisition information submitted by the oil machine subsystem.

Alternatively, in another case, the payment operation in the process of refueling in the gas station may be completed by using a network account subsystem and a vehicle is allowed to leave the gas station only after a generated order is paid immediately. Therefore, entering and leaving information of vehicles in each gas station may also be determined according to generation of transaction orders associated with the gas station, and so on.

In a specific implementation manner, as described in Embodiment 1 and Embodiment 5 above, there may be a variety of specific manners of generating an order. For example, in one manner, the service terminal of the network account subsystem may be further configured to provide an association relation between user payment account information and vehicle identifier information. For example, when a transaction order is generated, the service terminal of the network account subsystem may receive identifier information of a vehicle that enters the gas station for refueling and resource information to be paid that are submitted by an oil machine subsystem, determine associated payment account information according to the vehicle identifier information, and generate a transaction order according to the payment account information and the resource information.

S904: Statistics is conducted on entering and leaving information of vehicles associated with the same gas station to obtain real-time busy or idle state information of the gas station.

Real-time busy or idle states of a gas station may be obtained through statistics on information such as the number of vehicles that go into the same gas station. For example, a gas station is in a busy state if a large number of vehicles go into the gas station. A gas station is in an idle state if no vehicles go into the gas station at the current moment and the oil gun of the gas station is in an unused state, and so on.

### EMBODIMENT 11

Embodiment 11 corresponds to Embodiment 10 and provides a method for providing gas station information in an electronic map system from the perspective of a client terminal of an electronic map system. For example, referring to FIG. 9, the method may, for example, include the following steps:

S1002: A client terminal of the electronic map system receives a gas station search request.

S1004: The request is submitted to a service terminal of the electronic map system, so that the service terminal searches for a matched gas station according to geographical location information of a terminal device associated with the client terminal, and obtains real-time busy or idle state information of the matched gas station from a network account subsystem.

S1006: Location information of the matched gas station on the map and the real-time busy or idle state information of the matched gas station are provided in an electronic map information interface according to a response returned by the service terminal.

### EMBODIMENT 12

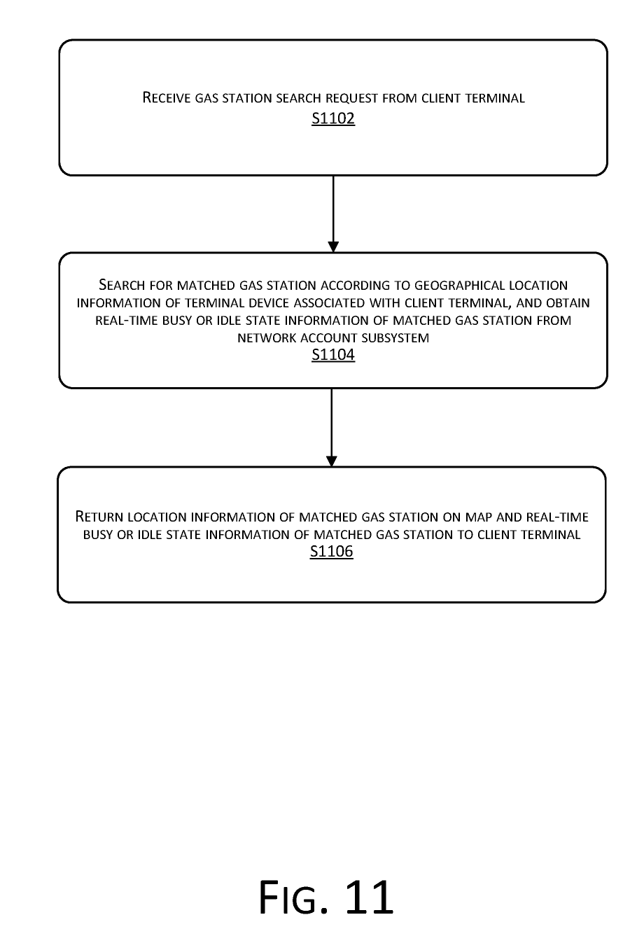

Embodiment 12 corresponds to Embodiment 11 and provides a method for providing gas station information in an electronic map system from the perspective of a service terminal of an electronic map system. For example, referring to FIG. 11, the method may, for example, include the following steps:

S1102: A service terminal of the electronic map system receives a gas station search request from a client terminal.

S1104: A matched gas station is searched for according to geographical location information of a terminal device associated with the client terminal, and real-time busy or idle state information of the matched gas station is obtained from a network account subsystem.

S1106: Location information of the matched gas station on the map and the real-time busy or idle state information of the matched gas station are returned to the client terminal, so that the client terminal provides the location information and the real-time busy or idle state information in an electronic map information interface.

In addition, in a specific implementation manner, promotion manner information provided by the matched gas station may also be obtained from the service terminal of the network account subsystem, and the promotion manner information of the matched gas station is provided in the electronic map information interface.

Moreover, link information of an operation entry for recharging a refueling card may also be obtained from the service terminal of the network account subsystem, and the operation entry for recharging a refueling card is provided in the electronic map information interface according to the link information.

### EMBODIMENT 13

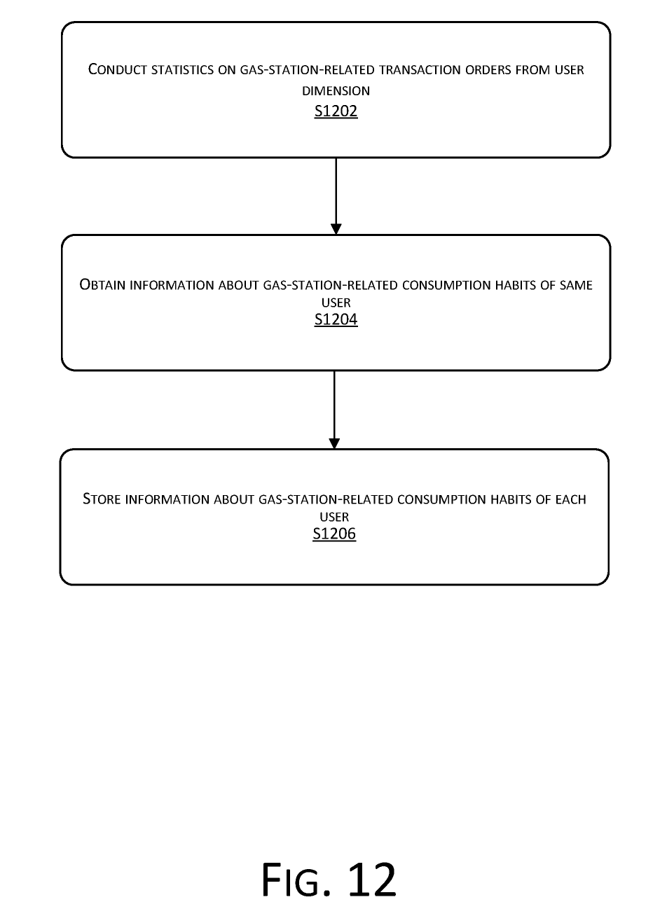

Embodiment 13 introduces another application scenario in which a network account subsystem conducts statistics on information of a gas station. For example, an information processing method for a gas station is provided first from the perspective of a service terminal of a network account subsystem. Referring to FIG. 12, the method may, for example, include the following steps:

S1202: A service terminal of a network account subsystem conducts statistics on gas-station-related transaction orders from a user dimension.

In a specific implementation manner, the service terminal of the network account subsystem is further configured to provide an association relation between user payment account information and vehicle identifier information, and may specifically generate the transaction order in the following manner:
receiving identifier information of a vehicle that enters the gas station for refueling and resource information to be paid that are submitted by an oil machine subsystem; and determining associated payment account information according to the identifier information of the vehicle, and generating a transaction order according to the payment account information and the resource information.

S1204: Information about gas-station-related consumption habits of the same user is obtained.

The information about gas-station-related consumption habits of the same user includes: information of a common gas station, information of a common oil product, whether the user often shops in a store associated with the gas station, and/or information of data objects purchased in the store.

S1206: Information about gas-station-related consumption habits of each user is stored.

### EMBODIMENT 14

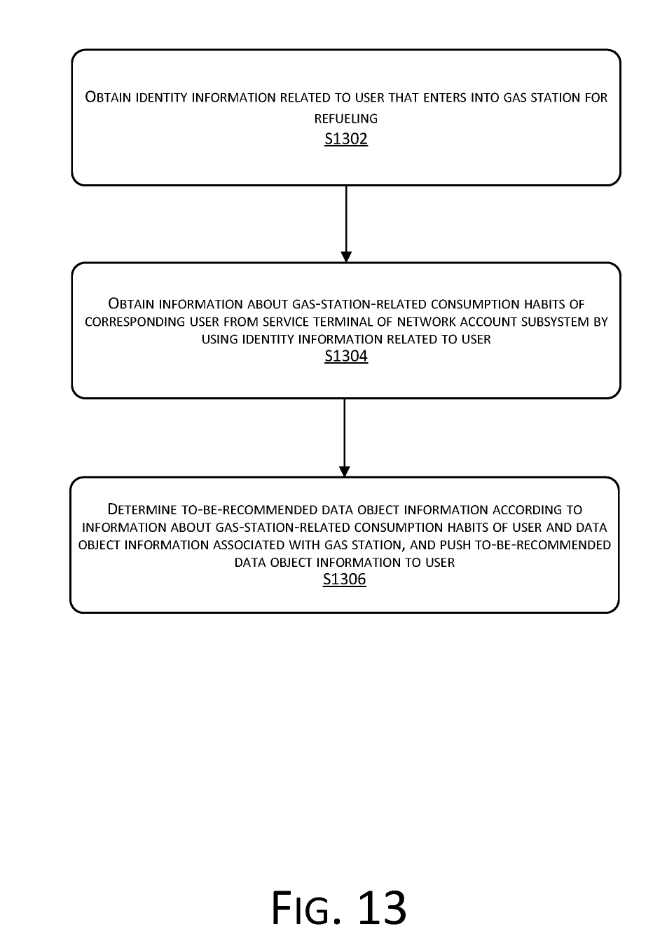

Embodiment 14 is a specific application of information about gas-station-related consumption habits of a user. For example, referring to FIG. 13, Embodiment 14 provides a method for pushing gas-station-related recommendation information from the perspective of an oil machine subsystem. For example, the method may include the following steps:

S1302: An oil machine subsystem obtains identity information related to a user that enters a gas station for refueling.

S1304: Information about gas-station-related consumption habits of the corresponding user is obtained from a service terminal of a network account subsystem by using the identity information related to the user.

S1306: To-be-recommended data object information is determined according to the information about gas-station-related consumption habits of the user and data object information associated with the gas station, and is pushed to the user.

In a specific implementation manner, the information obtained from the network account subsystem may further include vehicle information associated with the user. In this case, to-be-recommended data object information may be determined according to the information about gas-station-related consumption habits of the user, the vehicle information associated with the user, and data object information associated with the gas station.

In an actual application, a WiFi probe device may be deployed in the gas station. For example, when identity information related to a user that enters a gas station for refueling is obtained, identifier information of a mobile terminal device associated with the user may be determined by detecting a WiFi signal of the user that enters the gas station, so that the network account subsystem determines a corresponding user identity according to the identifier information of the mobile terminal device and determines corresponding information about gas-station-related consumption habits.

### EMBODIMENT 15

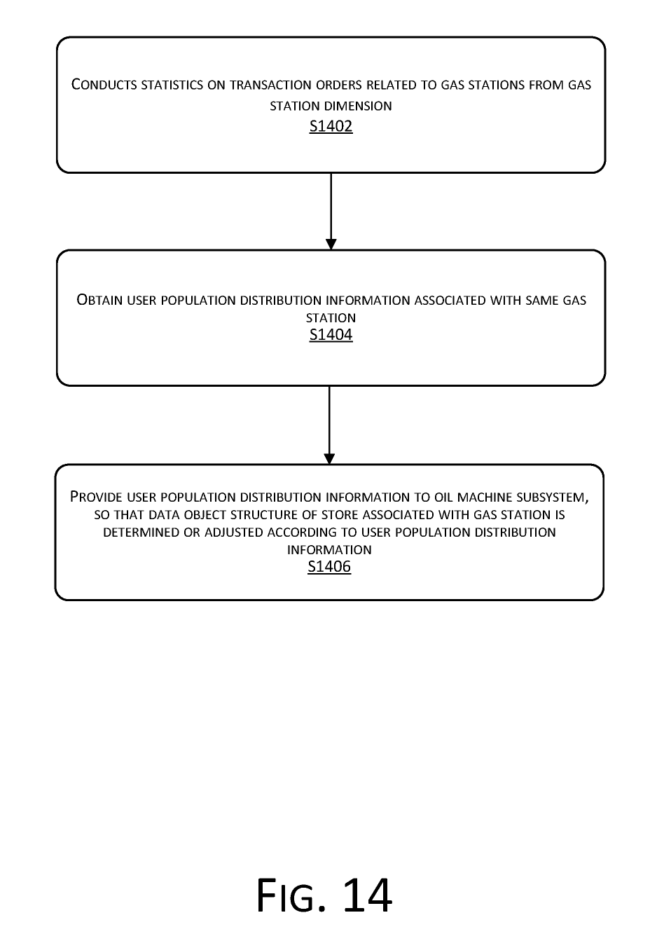

Embodiment 13 provides another application scenario in which a service terminal of a network account subsystem conducts statistics on gas-station-related information. For example, referring to FIG. 14, Embodiment 13 provides a method for conducting statistics on information of a gas station. The method may, for example, include the following steps:

S1402: A service terminal of a network account subsystem conducts statistics on transaction orders related to gas stations from a gas station dimension.

S1404: User population distribution information associated with the same gas station is obtained.

Here, user group feature information associated with the same gas station is obtained. For example, the user group feature information may specifically include: an age group to which most users belong, educational backgrounds and occupations of most users, and so on.

S1406: The user population distribution information is provided to an oil machine subsystem, so that a data object structure of a store associated with the gas station is determined or adjusted according to the user population distribution information.

In addition, in a specific implementation manner, the service terminal of the network account subsystem may further pre-store a corresponding relationship between users and vehicle information. In this case, vehicle feature information associated with the same gas station may also be obtained. For example, brands and grades of vehicles that go into the same gas station for refueling, the number of vehicles coming to the gas station for refueling every day, and so on. Vehicle information in more detail may also be acquired or confirmed by using a monitoring device such as an image acquisition system deployed in the gas station.

In a specific implementation manner, the service terminal of the network account subsystem is further configured to provide an association relation between user payment account information and vehicle identifier information, and may specifically generate the transaction order in the following manner:
receiving identifier information of a vehicle that enters the gas station for refueling and resource information to be paid that are submitted by an oil machine subsystem; and determining associated payment account information according to the identifier information of the vehicle, and generating a transaction order according to the payment account information and the resource information.

For parts that are not described in detail in the specific implementations of the steps in Embodiment 10 to Embodiment 15 above, reference may be made to the introduction in the foregoing embodiments. Details are not described here again.

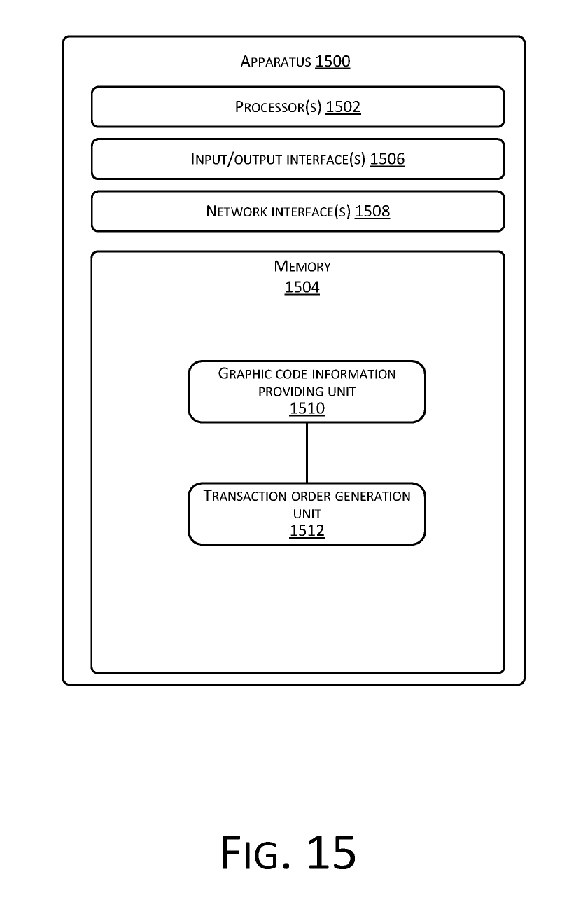

Corresponding to Embodiment 2, an embodiment of the present disclosure further provides a data processing apparatus 1500 for a gas station. Referring to FIG. 15, the apparatus 1500 is applied to a service terminal of a network account subsystem and includes one or more processor(s) 1502 or data processing unit(s) and memory 1504. The apparatus 1500 may further include one or more input/output interface(s) 1506 and one or more network interface(s) 1508. The memory 1504 is an example of computer readable media.

Computer readable media, including both permanent and non-permanent, removable and non-removable media, may be stored by any method or technology for storage of information. The information can be computer readable instructions, data structures, modules of programs, or other data. Examples of computer storage media include, but are not limited to, phase change memory (PRAM), static random access memory (SRAM), dynamic random access memory (DRAM), other types of random access memory (RAM), read only memory Such as ROM, EEPROM, flash memory or other memory technology, CD-ROM, DVD, or other optical storage, Magnetic cassettes, magnetic tape magnetic tape storage or other magnetic storage devices, or any other non-transitory medium, may be used to store information that may be accessed by a computing device. As defined herein, computer readable media do not include transitory media such as modulated data signals and carriers.

The memory 1504 may store therein a plurality of modules or units including:

a graphic code information providing unit 1510 configured to provide a client terminal with information of a graphic code carrying user payment account information, so that the graphic code is displayed to a code scanning subsystem through the client terminal; and a transaction order generation unit 1512 configured to generate a transaction order after receiving resource information to be paid for refueling provided by the code scanning subsystem and payment account information which is submitted by the code scanning subsystem through scanning the graphic code.

In a specific implementation manner, the apparatus may further include the following units (not shown in FIG. 15):
an order submitting unit configured to provide information of the transaction order to an associated payment subsystem, so that the payment subsystem pays for the transaction order; and
a payment success information providing unit configured to provide payment success information to an oil machine subsystem after the payment success information is obtained from the payment subsystem, so that the oil machine subsystem provides the payment success information to the code scanning subsystem.

In addition, the apparatus may further include the following units (not shown in FIG. 15):
a corresponding relationship storage unit configured to store a corresponding relationship between user payment accounts and vehicle identifier information; and
a vehicle identifier information providing unit configured to provide information of an associated vehicle identifier to the oil machine subsystem when the payment success information is provided to the oil machine subsystem, to serve as a basis for releasing a vehicle corresponding to the vehicle identifier.

In a specific implementation manner, the information submitted by the code scanning subsystem may further include gas station identifier information, identifier information of a filled oil product and/or quantity information of the filled oil product. In this case, the transaction order generation unit is further configured to:
add the gas station identifier information, the identifier information of the filled oil product and/or the quantity information of the filled oil product to the transaction order.

In this case, the apparatus may further include the following unit (not shown in FIG. 15):
an invoice operation option providing unit configured to provide, in an interface of the order, an invoice issuing operation option to be used for issuing an electronic invoice online.

In a specific implementation manner, the graphic code further carries membership information registered with the gas station by a corresponding user.

If the membership information is associated with information about consumer rights and interests, the apparatus may further include the following unit (not shown in FIG. 15):
a verification and cancelation unit configured to cancel the consumer rights and interests after verification according to a condition corresponding to the information about the consumer rights and interests when the transaction order is generated.

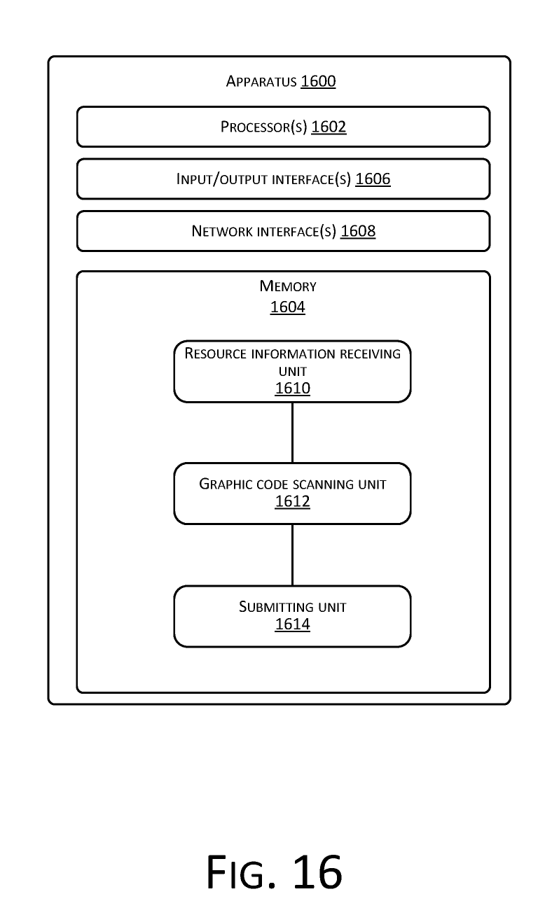

Corresponding to Embodiment 3, an embodiment of the present disclosure further provides a data processing apparatus 1600 for a gas station. Referring to FIG. 16, the apparatus 1600 is applied to a code scanning subsystem and includes one or more processor(s) 1602 or data processing unit(s) and memory 1604. The apparatus 1600 may further include one or more input/output interface(s) 1606 and one or more network interface(s) 1608. The memory 1604 is an example of computer readable media.

The memory 1604 may store therein a plurality of modules or units including:
a resource information receiving unit 1610 configured to receive resource information to be paid for refueling provided by an oil machine subsystem;
a graphic code scanning unit 1612 configured to scan a graphic code displayed by a client terminal of a network account subsystem, the graphic code carrying user payment account information; and
a submitting unit 1614 configured to provide a service terminal of the network account subsystem with the code scanning result and the resource information to be paid, so that the service terminal of the network account subsystem generates a transaction order.

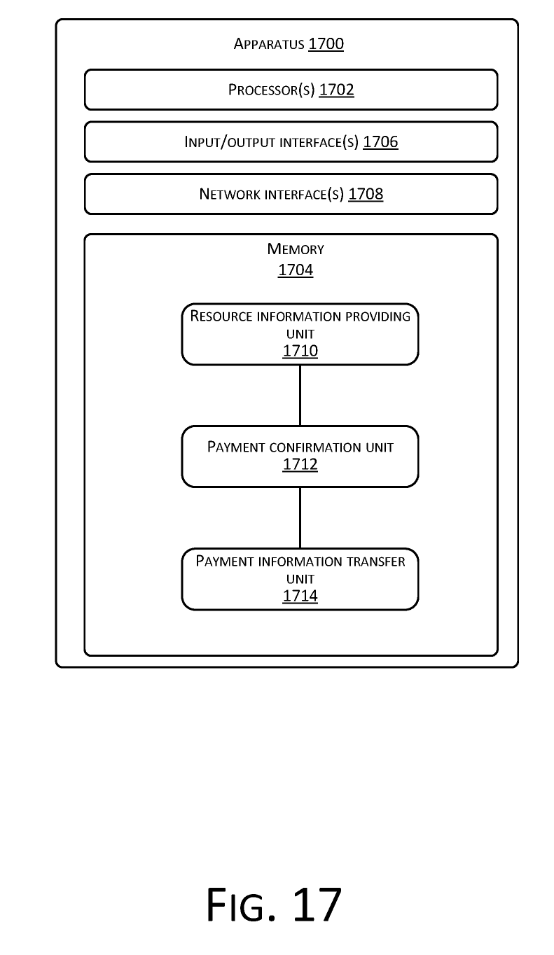

Corresponding to Embodiment 4, an embodiment of the present disclosure further provides a data processing apparatus 1700 for a gas station. Referring to FIG. 17, the apparatus 1700 is applied to an oil machine subsystem and includes one or more processor(s) 1702 or data processing unit(s) and memory 1704. The apparatus 1700 may further include one or more input/output interface(s) 1706 and one or more network interface(s) 1708. The memory 1704 is an example of computer readable media.

The memory 1704 may store therein a plurality of modules or units including:
a resource information providing unit 1710 configured to obtain resource information to be paid for refueling and provide the resource information to a code scanning subsystem;
a payment confirmation unit 1712 configured to request to obtain payment confirmation information from a service terminal of a network account subsystem after receiving a code scanning completion notification message provided by the code scanning subsystem, wherein a service terminal of the code scanning subsystem is configured to scan a graphic code carrying user payment account information that is provided by a client terminal of the network account subsystem, and provide the service terminal of the network account subsystem with the resource information to be paid, so that the service terminal of the network account subsystem generates a transaction order; and
a payment information transfer unit 1714 configured to provide payment success information to the code scanning subsystem after obtaining the payment success information from the service terminal of the network account subsystem.

In a specific implementation manner, the apparatus 1700 may further include the following units (not shown in FIG. 17):
a vehicle identifier information obtaining unit configured to obtain associated vehicle identifier information from the service terminal of the network account subsystem; and
a vehicle identifier information providing unit configured to further provide the vehicle identifier information to the code scanning subsystem when the payment success information is provided to the code scanning subsystem.

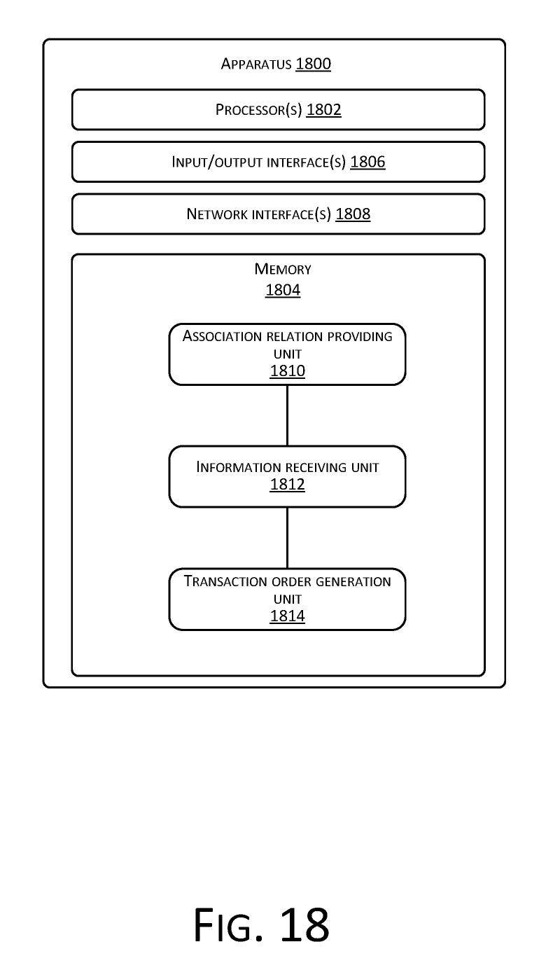

Corresponding to Embodiment 6, an embodiment of the present disclosure further provides a data processing apparatus 1800 for a gas station. Referring to FIG. 18, the apparatus 1800 is applied to a service terminal of a network account subsystem and includes one or more processor(s) 1802 or data processing unit(s) and memory 1804. The apparatus 1800 may further include one or more input/output interface(s) 1806 and one or more network interface(s) 1808. The memory 1804 is an example of computer readable media.

The memory 1804 may store therein a plurality of modules or units including:
an association relation providing unit 1810 configured to provide an association relation between user payment account information and vehicle identifier information;
an information receiving unit 1812 configured to receive identifier information of a vehicle that enters the gas station for refueling and resource information to be paid that are submitted by an oil machine subsystem; and
a transaction order generation unit 1814 configured to determine associated payment account information according to the vehicle identifier information, and generate a transaction order according to the payment account information and the resource information.

In a specific implementation manner, the apparatus 1800 may further include the following units (not shown in FIG. 18):
a required information providing unit configured to provide oil product and quantity information required by the associated vehicle to the oil machine subsystem; and
a fuel tank cap information providing unit configured to provide position and opening manner information of a fuel tank cap of the associated vehicle to the oil machine subsystem.

In an actual application, the apparatus 1800 may further include the following units (not shown in FIG. 18):
a gas station state information determination unit configured to determine real-time busy or idle state information of the gas station according to identifier information of vehicles that go into the corresponding gas station and states of all the vehicles that are provided by the oil machine subsystem; and
a gas station state information providing unit configured to provide the real-time busy or idle state information of the gas station to an electronic map system, so that the electronic map system further provides the real-time busy or idle state information of the gas station while providing a gas station search result.

In addition, the apparatus 1800 may further include the following units (not shown in FIG. 18):
a promotion manner information providing unit configured to provide the electronic map system with promotion manner information of the gas station that is provided by the oil machine subsystem; and
a recharging operation entry providing unit configured to provide the electronic map system with an operation entry for recharging a refueling card.

In another application manner, the apparatus 1800 may further include the following units (not shown in FIG. 18):
a user habit information statistical unit configured to conduct statistics on transaction orders that are associated with the same user and related to consumption in gas stations, to obtain and store refueling consumption habit information.

In a specific implementation manner, a WiFi probe device may be further deployed in the gas station, and the apparatus may further include:
a terminal device identifier information obtaining unit configured to identify, by using the WiFi probe device, identifier information of a terminal device associated with a user that enters the gas station for refueling;
a consumption habit information obtaining unit configured to determine associated user account information according to the identifier of the terminal device, and obtain refueling consumption habit information of the user by using the user account information; and
a recommendation information pushing unit configured to push data object recommendation information to the user according to the refueling consumption habit information and a data object list associated with the gas station.

Moreover, the apparatus 1800 may further include the following unit (not shown in FIG. 18):
a population/vehicle information statistical unit configured to conduct statistics on population distribution information and/or vehicle feature information of the same gas station according to transaction orders associated with an identifier of the same gas station, so as to determine or adjust a data object structure in a store associated with the gas station.

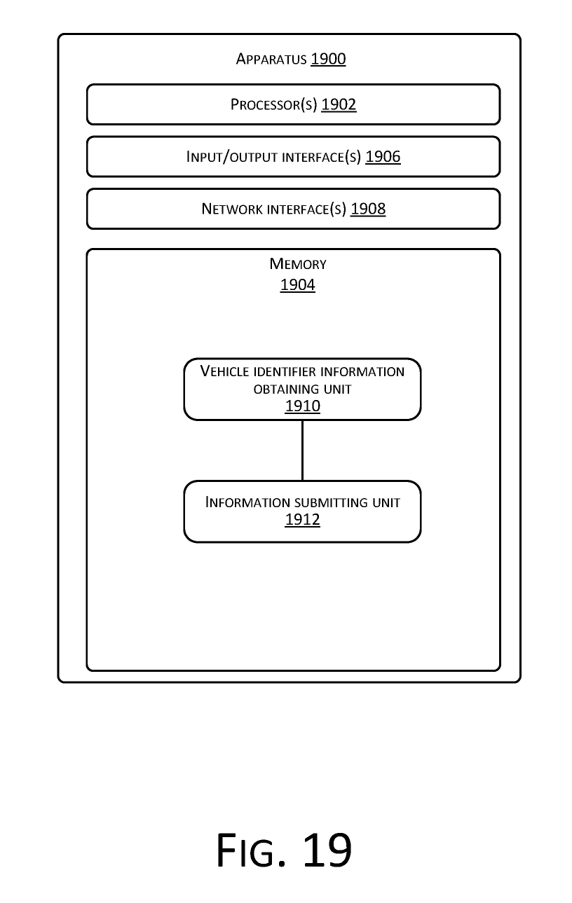

Corresponding to Embodiment 7, an embodiment of the present disclosure further provides a data processing apparatus 1900 for a gas station. Referring to FIG. 19, the apparatus 1900 is applied to an oil machine subsystem and includes one or more processor(s) 1902 or data processing unit(s) and memory 1904. The apparatus 1800 may further include one or more input/output interface(s) 1906 and one or more network interface(s) 1908. The memory 1904 is an example of computer readable media.

The memory 1904 may store therein a plurality of modules or units including:
a vehicle identifier information obtaining unit 1910 configured to obtain identifier information of a vehicle that enters the gas station for refueling from an image acquisition subsystem; and
an information submitting unit 1912 configured to determine resource information to be paid for refueling, and then provide the identified identifier information of the vehicle and the resource information to a service terminal of a network account subsystem, so that the service terminal of the network account subsystem determines associated user payment account information according to the identifier information of the vehicle, and generates a refueling transaction order based on the resource information to be paid.

In a specific implementation manner, the apparatus 1900 may further include the following unit (not shown in FIG. 19):
a required information obtaining unit configured to obtain information about oil product as well as quantity required for refueling from the service terminal of the network account subsystem.

A display screen is further deployed in the gas station, and in this case, the apparatus may further include:
a display information output unit configured to output the required oil product and quantity information obtained from the service terminal of the network account subsystem to the display screen deployed in the gas station for display.

Alternatively, the gas station further includes a mechanical arm for refueling, the mechanical arm being provided with a controller, and the apparatus may further include:
a control information output unit configured to output the required oil product and quantity information obtained from the service terminal of the network account subsystem to the controller of the mechanical arm, so that the controller of the mechanical arm controls the mechanical arm to complete a refueling process.

In addition, the apparatus 1900 may further include the following unit (not shown in FIG. 19):
a fuel tank cap information processing unit configured to provide position and opening manner information of a fuel tank cap obtained from the service terminal of the network account subsystem to the controller of the mechanical arm, so that the controller generates a corresponding operation instruction, and the mechanical arm completes operations to position and open the fuel tank cap.

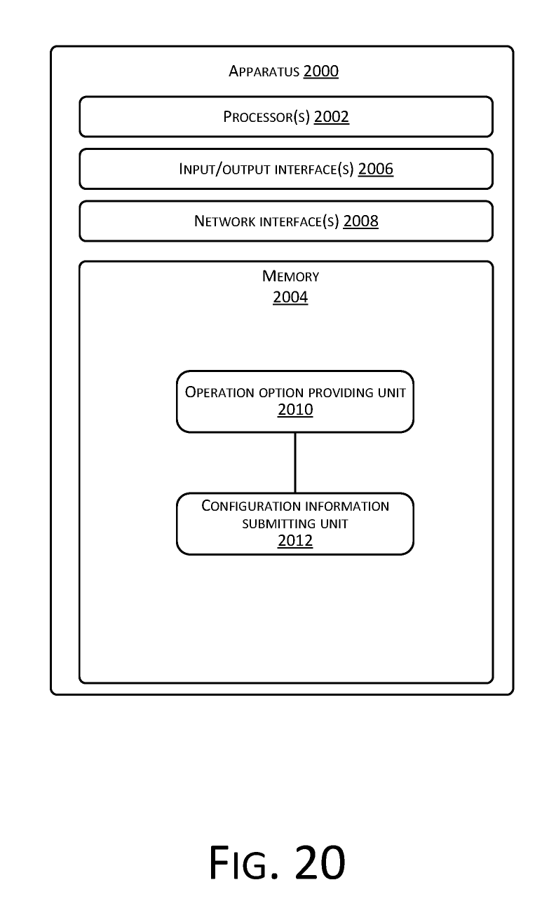

Corresponding to Embodiment 8, an embodiment of the present disclosure further provides an information processing apparatus 2000 for a gas station. Referring to FIG. 20, the apparatus 2000 is applied to a client terminal of a network account subsystem and includes one or more processor(s) 2002 or data processing unit(s) and memory 2004. The apparatus 2000 may further include one or more input/output interface(s) 2006 and one or more network interface(s) 2008. The memory 2004 is an example of computer readable media.

The memory 2004 may store therein a plurality of modules or units including:
an operation option providing unit 2010 configured to provide, in a user interface, an operation option for configuring vehicle identifier information, required oil product information, and required refueling quantity information; and
a configuration information submitting unit 2012 configured to submit specific configuration information received through the operation option to a service terminal of the network account subsystem, so that the service terminal stores the specific configuration information and provides the specific configuration information to an oil machine subsystem when a vehicle enters the gas station for refueling.

In a specific implementation manner, the operation option providing unit 2010 may be further configured to: provide an operation option for configuring position information and opening manner information of a fuel tank cap of the vehicle; and
the configuration information submitting unit 2012 may be further configured to: submit specific configuration information about the fuel tank cap received through the operation option to the service terminal of the network account subsystem, so that the service terminal stores the specific configuration information and provides the specific configuration information to the oil machine subsystem when the vehicle enters the gas station for refueling, and the oil machine subsystem provides the specific configuration information of the fuel tank cap to a controller of a mechanical arm of an oil machine.

In a specific implementation manner, the apparatus 2000 may further include the following unit (not shown in FIG. 20):
an optional description information providing unit configured to provide multiple optional pieces of position information and multiple optional opening manners of fuel tank caps according to pre-generated standard description information of positions and opening manners, so that a specific piece of position information and a specific opening manner are selected therefrom to facilitate the controller of the mechanical arm to generate a control instruction.

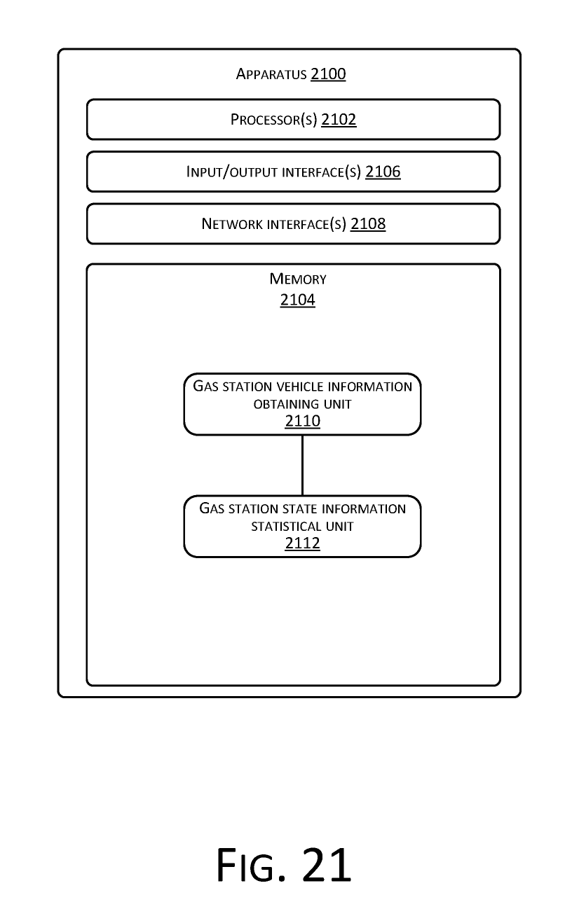

Corresponding to Embodiment 10, an embodiment of the present disclosure further provides a state information processing apparatus 2100 for a gas station. Referring to FIG. 21, the apparatus is applied to a network account subsystem service terminal and includes one or more processor(s) 2102 or data processing unit(s) and memory 2104. The apparatus 2100 may further include one or more input/output interface(s) 2106 and one or more network interface(s) 2108. The memory 2104 is an example of computer readable media. The memory 2104 may store therein a plurality of modules or units including:
a gas station vehicle information obtaining unit 2110 configured to obtain identifier information of vehicles that go into and out of the gas station from an oil machine subsystem of the gas station; and
a gas station state information statistical unit 2112 configured to conduct statistics on entering and leaving information of vehicles associated with the same gas station to obtain real-time busy or idle state information of the gas station.

In a specific implementation manner, an image acquisition device may be deployed in the gas station. The image acquisition device is configured to acquire images of vehicles that go into and out of the gas station. The gas station vehicle information obtaining unit may be specifically configured to:
determine, according to image acquisition information submitted by the oil machine subsystem, information of vehicles that go into and out of the gas station.

Alternatively, the service terminal of the network account subsystem is further configured to generate transaction orders for vehicles that go into the gas station for refueling, and the gas station vehicle information obtaining unit may be specifically configured to:
determine entering and leaving information of vehicles in each gas station according to generation of transaction orders associated with the gas station.

In a specific implementation manner, the service terminal of the network account subsystem may be further configured to provide an association relation between user payment account information and vehicle identifier information; in this case, the transaction order may be generated in the following manner:
receiving identifier information of a vehicle that enters the gas station for refueling and resource information to be paid that are submitted by an oil machine subsystem; and determining associated payment account information according to the identifier information of the vehicle, and generating a transaction order according to the payment account information and the resource information.

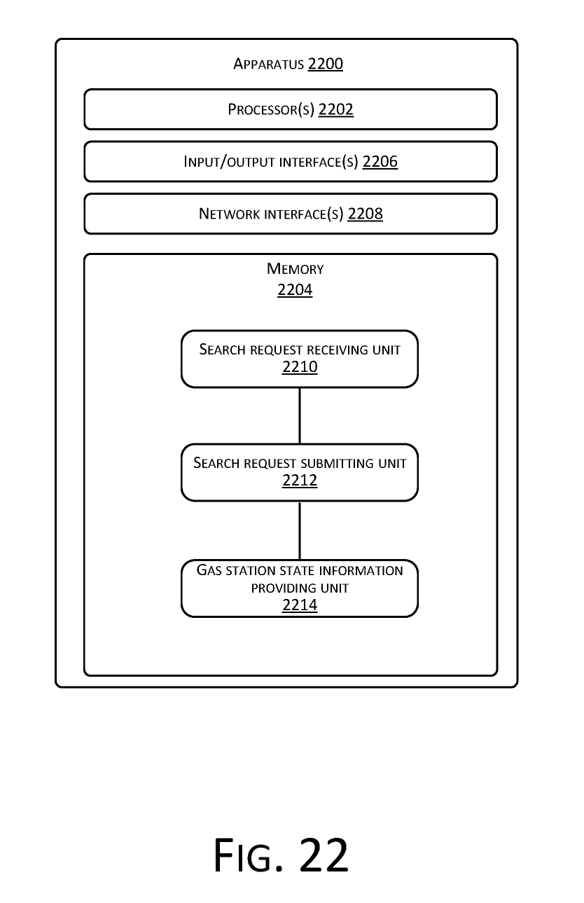

Corresponding to Embodiment 11, an embodiment of the present disclosure further provides an apparatus 2200 for providing gas station information in an electronic map system. Referring to FIG. 22, the apparatus 2200 is applied to a client terminal of an electronic map system and includes one or more processor(s) 2202 or data processing unit(s) and memory 2204. The apparatus 2200 may further include one or more input/output interface(s) 2206 and one or more network interface(s) 2208. The memory 2204 is an example of computer readable media. The memory 2204 may store therein a plurality of modules or units including:
a search request receiving unit 2210 configured to receive a gas station search request;
a search request submitting unit 2212 configured to submit the request to a service terminal of the electronic map system, so that the service terminal searches for a matched gas station according to geographical location information of a terminal device associated with the client terminal, and obtains real-time busy or idle state information of the matched gas station from a service terminal of a network account subsystem; and
a gas station state information providing unit 2214 configured to provide, in an electronic map information interface, location information of the matched gas station on the map and the real-time busy or idle state information of the matched gas station according to a response returned by the service terminal.

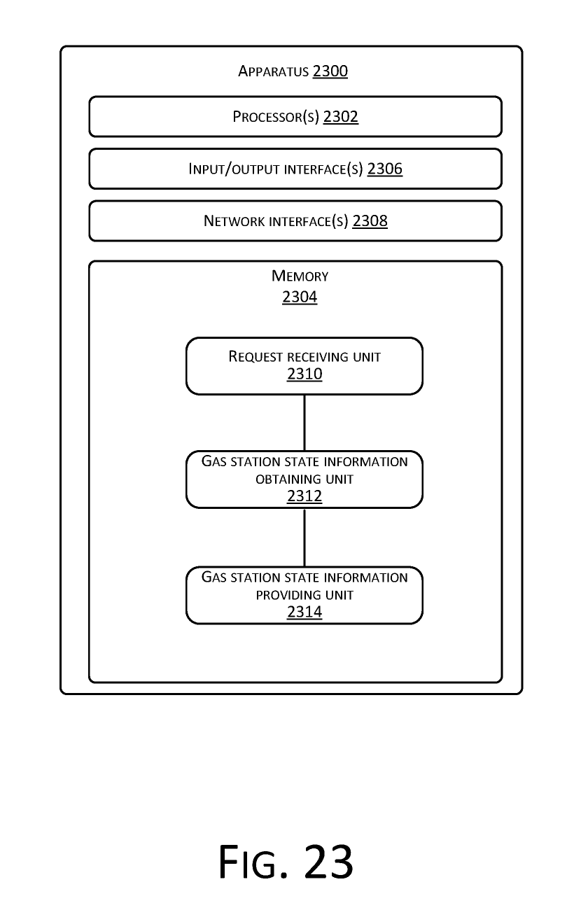

Corresponding to Embodiment 12, an embodiment of the present disclosure further provides an apparatus 2300 for providing gas station information in an electronic map system. Referring to FIG. 23, the apparatus 2300 is applied to a service terminal of an electronic map system and includes one or more processor(s) 2302 or data processing unit(s) and memory 2304. The apparatus 2300 may further include one or more input/output interface(s) 2306 and one or more network interface(s) 2308. The memory 2304 is an example of computer readable media. The memory 2304 may store therein a plurality of modules or units including:
a request receiving unit 2310 configured to receive a gas station search request from a client terminal;
a gas station state information obtaining unit 2312 configured to search for a matched gas station according to geographical location information of a terminal device associated with the client terminal, and obtain real-time busy or idle state information of the matched gas station from a network account subsystem; and
a gas station state information providing unit 2314 configured to return location information of the matched gas station on the map and the real-time busy or idle state information of the matched gas station to the client terminal, so that the client terminal provides the location information and the real-time busy or idle state information in an electronic map information interface.

In a specific implementation manner, the apparatus 2300 may further include the following units (not shown in FIG. 23):
a promotion manner information obtaining unit configured to obtain promotion manner information provided by the matched gas station from a service terminal of a network account subsystem; and
a promotion manner information providing unit configured to provide the promotion manner information of the matched gas station in the electronic map information interface.

In addition, the apparatus 2300 may further include the following units (not shown in FIG. 23):
a recharging operation entry information obtaining unit configured to obtain link information of an operation entry for recharging a refueling card from the service terminal of the network account subsystem; and
a recharging operation entry information providing unit configured to provide the operation entry for recharging a refueling card in the electronic map information interface according to the link information.

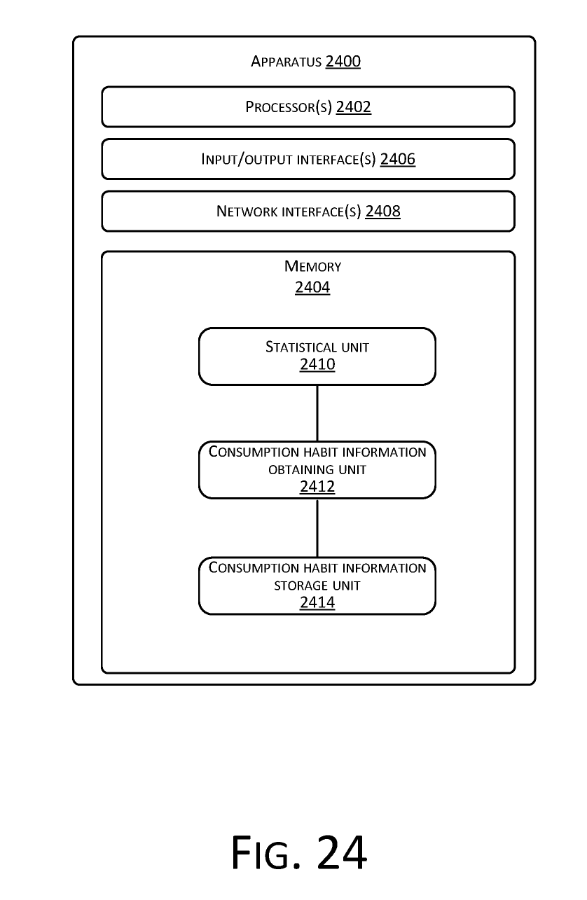

Corresponding to Embodiment 13, an embodiment of the present disclosure further provides an information processing apparatus 2400 for a gas station. Referring to FIG. 24, the apparatus 2400 is applied to a service terminal of a network account subsystem and includes one or more processor(s) 2402 or data processing unit(s) and memory 2404. The apparatus 2400 may further include one or more input/output interface(s) 2406 and one or more network interface(s) 2408. The memory 2404 is an example of computer readable media. The memory 2404 may store therein a plurality of modules or units including:
a statistical unit 2410 configured to conduct statistics on gas-station-related transaction orders from a user dimension;
a consumption habit information obtaining unit 2412 configured to obtain information about gas-station-related consumption habits of the same user; and
a consumption habit information storage unit 2414 configured to store information about gas-station-related consumption habits of each user.

In a specific implementation manner, the service terminal of the network account subsystem may be further configured to provide an association relation between user payment account information and vehicle identifier information; and the transaction order may be specifically generated in the following manner:
receiving identifier information of a vehicle that enters the gas station for refueling and resource information to be paid that are submitted by an oil machine subsystem; and
determining associated payment account information according to the identifier information of the vehicle, and generating a transaction order according to the payment account information and the resource information.

The information about gas-station-related consumption habits of the same user includes: information of a common gas station, information of a common oil product, whether the user often shops in a store associated with the gas station, and/or information of data objects purchased in the store.

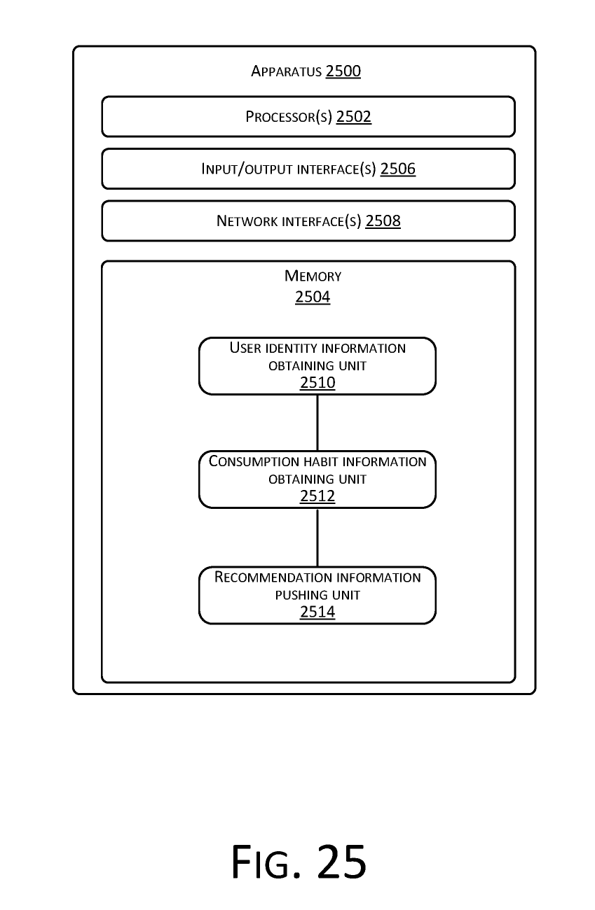

Corresponding to Embodiment 14, an embodiment of the present disclosure further provides an apparatus 2500 for pushing gas-station-related recommendation information. Referring to FIG. 25, the apparatus 2500 is applied to an oil machine subsystem and includes one or more processor(s) 2502 or data processing unit(s) and memory 2504. The apparatus 2500 may further include one or more input/output interface(s) 2506 and one or more network interface(s) 2508. The memory 2504 is an example of computer readable media. The memory 2504 may store therein a plurality of modules or units including:
a user identity information obtaining unit 2510 configured to obtain identity information related to a user that enters a gas station for refueling;
a consumption habit information obtaining unit 2512 configured to obtain information about gas-station-related consumption habits of the corresponding user from a service terminal of a network account subsystem by using the identity information related to the user; and
a recommendation information pushing unit 2514 configured to determine to-be-recommended data object information according to the information about gas-station-related consumption habits of the user and data object information associated with the gas station, and push the to-be-recommended data object information to the user.

In a specific implementation manner, the information obtained from the service terminal of the network account subsystem may further include vehicle information associated with the user, and the recommendation information pushing unit 2514 may be specifically configured to:
determine to-be-recommended data object information according to the information about gas-station-related consumption habits of the user, the vehicle information associated with the user, and the data object information associated with the gas station.

In addition, a WiFi probe device may be deployed in the gas station, and the user identity information obtaining unit 2510 may be specifically configured to:
determine identifier information of a mobile terminal device associated with the user by detecting a WiFi signal of the user that enters the gas station, so that the service terminal of the network account subsystem determines a corresponding user identity according to the identifier information of the mobile terminal device and determines corresponding information about gas-station-related consumption habits.

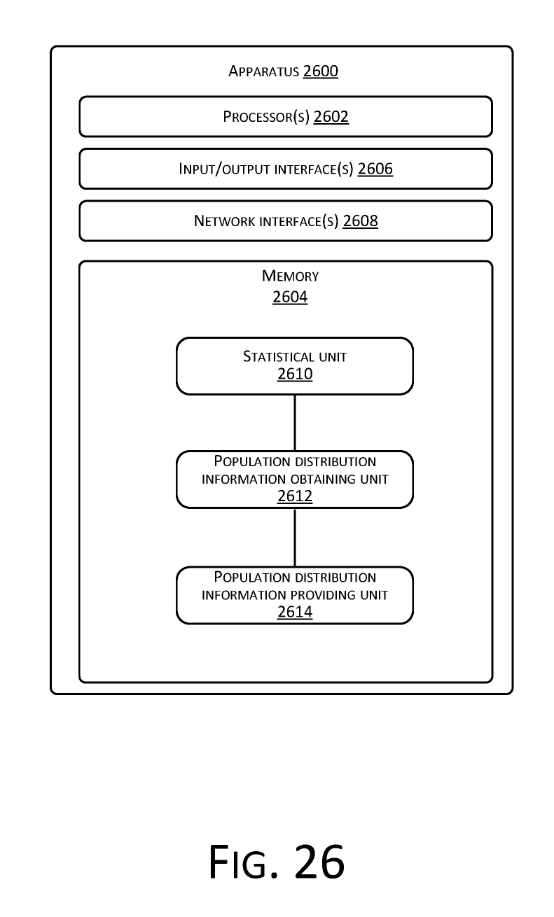

Corresponding to Embodiment 15, an embodiment of the present disclosure further provides an apparatus 2600 for conducting statistics on information of a gas station. Referring to FIG. 26, the apparatus 2600 is applied to a service terminal of a network account subsystem and includes one or more processor(s) 2602 or data processing unit(s) and memory 2604. The apparatus 2600 may further include one or more input/output interface(s) 2606 and one or more network interface(s) 2608. The memory 2604 is an example of computer readable media. The memory 2604 may store therein a plurality of modules or units including:
a statistical unit 2610 configured to conduct statistics on transaction orders related to gas stations from a gas station dimension;
a population distribution information obtaining unit 2612 configured to obtain user population distribution information associated with the same gas station; and
a population distribution information providing unit 2614 configured to provide the user population distribution information to an oil machine subsystem, so that a data object structure of a store associated with the gas station is determined or adjusted according to the user population distribution information.

In a specific implementation manner, the service terminal of the network account subsystem pre-stores a corresponding relationship between users and vehicle information, and the apparatus 2600 further includes the following unit (not shown in FIG. 26):
a vehicle feature information obtaining unit configured to obtain vehicle feature information associated with the same gas station, and provide the vehicle feature information to the oil machine subsystem.

In a specific implementation manner, the service terminal of the network account subsystem may be further configured to provide an association relation between user payment account information and vehicle identifier information; in this case, the transaction order may be specifically generated in the following manner:
receiving identifier information of a vehicle that enters the gas station for refueling and resource information to be paid that are submitted by an oil machine subsystem; and determining associated payment account information according to the identifier information of the vehicle, and generating a transaction order according to the payment account information and the resource information.

According to the description of the implementations above, those skilled in the art may clearly understand that the present disclosure may be implemented by software plus a necessary universal hardware platform. Based on such understanding, the technical solutions of the present disclosure essentially, or the portion contributing to the conventional techniques may be embodied in the form of a software product. The computer software product may be stored in a storage medium, such as a ROM/RAM, a magnetic disk, or an optical disc, and include several instructions that enable a computer device (which may be a personal computer, a server, a network device, or the like) to execute the method in the embodiments or certain portions of the embodiments of the present disclosure.

The embodiments in the specification are all described progressively. Identical or similar parts of the embodiments may be obtained with reference to each other. Each embodiment emphasizes a part different from other embodiments. Especially, the system or system embodiment is basically similar to the method embodiment, so it is described simply. For related parts, refer to the descriptions of the parts in the method embodiment. The systems and the system embodiments described above are merely exemplary. The units described as separate parts in the systems or system embodiments may or may not be physically separate, and parts displayed as units may or may not be physical units, and may be located in one position or may be distributed on a plurality of network units. Some or all of the modules may be selected according to actual needs to achieve the objectives of the solutions of the embodiments. Those of ordinary skill in the art may understand and implement the systems and the system embodiments without creative efforts.

The data processing method, apparatus, and system for a gas station provided in the present disclosure are described in detail above. The principle and implementations of the present disclosure are described in this text through specific examples. The description about the embodiments is merely provided for helping understand the method and core ideas of the present disclosure. At the same time, those of ordinary skill in the art may make variations to the present disclosure in terms of the specific implementations and application scopes according to the ideas of the present disclosure. Therefore, the content of the specification shall not be construed as limitations to the present disclosure.

The present disclosure may further he understood with clauses as follows.

Clause 1. A data processing system for a gas station, comprising:
an oil machine subsystem, a code scanning subsystem, and a service terminal of a network account subsystem;
the service terminal of the network account subsystem being configured to provide a client terminal with information of a graphic code carrying user payment account information, and generate a transaction order after receiving payment account information which is submitted by the code scanning subsystem through code scanning and resource information to be paid for refueling;
the code scanning subsystem being configured to scan the graphic code displayed by the client terminal of the network account subsystem after learning the resource information to be paid for refueling, and submit a code scanning result to the service terminal of the network account subsystem; and
the oil machine subsystem being configured to obtain the resource information to be paid for refueling and provide the resource information to the code scanning subsystem.

Clause 2. The system of clause 1, wherein the oil machine subsystem is further configured to:
request to obtain payment confirmation information from the service terminal of the network account subsystem after receiving a code scanning completion notification message provided by the code scanning subsystem and provide payment success information to the code scanning subsystem after obtaining the payment success information.

Clause 3. The system of clause 2, wherein the service terminal of the network account subsystem is further configured to provide a corresponding relationship between user payment accounts and vehicle identifier information, and provide associated vehicle identifier information to the oil machine subsystem when providing the payment success information to the oil machine subsystem; and
the oil machine subsystem is further configured to provide the vehicle identifier information to the code scanning subsystem.

Clause 4. A data processing method for a gas station, comprising:
providing, by a service terminal of a network account subsystem, a client terminal with information of a graphic code carrying user payment account information, so that the graphic code is displayed to a code scanning subsystem through the client terminal; and
generating a transaction order after receiving resource information to be paid for refueling provided by the code scanning subsystem and payment account information which is submitted by the code scanning subsystem through scanning the graphic code.

Clause 5. The method of clause 4, further comprising:
providing information of the transaction order to an associated payment subsystem, so that the payment subsystem pays for the transaction order; and
providing payment success information to an oil machine subsystem after the payment success information is obtained from the payment subsystem, so that the oil machine subsystem provides the payment success information to the code scanning subsystem.

Clause 6. The method of clause 5, further comprising:
storing a corresponding relationship between user payment accounts and vehicle identifier information; and
providing information of an associated vehicle identifier to the oil machine subsystem when the payment success information is provided to the oil machine subsystem, to serve as a basis for releasing a vehicle corresponding to the vehicle identifier.

Clause 7. The method of clause 4, wherein the information submitted by the code scanning subsystem further comprises gas station identifier information, identifier information of a filled oil product and/or quantity information of the filled oil product, and the step of generating a transaction order further comprises:

adding the gas station identifier information, the identifier information of the filled oil product and/or the quantity information of the filled oil product to the transaction order.

Clause 8. The method of clause 7, further comprising:
providing, in an interface of the order, an invoice issuing operation option to be used for issuing an electronic invoice online.

Clause 9. The method of clause 5, wherein the graphic code further carries membership information registered with the gas station by a corresponding user.

Clause 10. The method of clause 9, wherein the membership information is associated with information about consumer rights and interests, and the method further comprises:
canceling the consumer rights and interests after verification according to a condition corresponding to the information about the consumer rights and interests when the transaction order is generated.

Clause 11. A data processing method for a gas station, comprising:
receiving, by a code scanning subsystem, resource information to be paid for refueling provided by an oil machine subsystem;
scanning a graphic code displayed by a client terminal of a network account subsystem, the graphic code carrying user payment account information; and
providing a service terminal of the network account subsystem with the code scanning result and the resource information to be paid, so that the service terminal of the network account subsystem generates a transaction order.

Clause 12. A data processing method for a gas station, comprising:
obtaining, by an oil machine subsystem, resource information to be paid for refueling, and providing the resource information to a code scanning subsystem;
requesting to obtain payment confirmation information from a service terminal of a network account subsystem after a code scanning completion notification message provided by the code scanning subsystem is received, wherein a service terminal of the code scanning subsystem is configured to scan a graphic code carrying user payment account information that is provided by a client terminal of the network account subsystem, and provide the service terminal of the network account subsystem with the resource information to be paid, so that the service terminal of the network account subsystem generates a transaction order; and
providing payment success information to the code scanning subsystem after the payment success information is obtained from the service terminal of the network account subsystem.

Clause 13. The method of clause 12, when payment success information is obtained from the service terminal of the network account subsystem, further comprising:
obtaining associated vehicle identifier information from the service terminal of the network account subsystem; and
providing the vehicle identifier information to the code scanning subsystem when the payment success information is provided to the code scanning subsystem.

Clause 14. A data processing system for a gas station, comprising:
a service terminal of a network account subsystem, an image acquisition subsystem and an oil machine subsystem;
the service terminal of the network account subsystem being configured to provide an association relation between user payment account information and vehicle identifier information;
the image acquisition subsystem being configured to acquire an image of a vehicle that enters the gas station for refueling, and identify vehicle identifier information according to an image acquisition result;
the oil machine subsystem being configured to obtain resource information to be paid for refueling and provide the identified vehicle identifier information and the resource information to the service terminal of the network account subsystem; and
the service terminal of the network account subsystem being further configured to determine associated user payment account information according to the vehicle identifier information and generate a refueling transaction order based on the resource information to be paid.

Clause 15. A data processing method for a gas station, comprising:
providing, by a service terminal of a network account subsystem, an association relation between user payment account information and vehicle identifier information;
receiving identifier information of a vehicle that enters the gas station for refueling and resource information to be paid that are submitted by an oil machine subsystem; and determining associated payment account information according to the identifier information of the vehicle, and generating a transaction order according to the payment account information and the resource information.

Clause 16. The method of clause 15, further comprising:
providing information about oil product as well as quantity required by the associated vehicle to the oil machine subsystem.

Clause 17. The method of clause 15, further comprising:
providing position and opening manner information of a fuel tank cap of the associated vehicle to the oil machine subsystem.

Clause 18. The method of clause 15, further comprising:
determining real-time busy or idle state information of the gas station according to identifier information of vehicles that go into the corresponding gas station and states of all the vehicles that are provided by the oil machine subsystem; and
providing the real-time busy or idle state information of the gas station to an electronic map system, so that the electronic map system further provides the real-time busy or idle state information of the gas station while providing a gas station search result.

Clause 19. The method of clause 18, further comprising:
providing the electronic map system with promotion manner information of the gas station that is provided by the oil machine subsystem.

Clause 20. The method of clause 18, further comprising:
providing the electronic map system with an operation entry for recharging a refueling card.

Clause 21. The method of clause 15, further comprising:
conducting statistics on transaction orders that are associated with the same user and related to consumption in gas stations, to obtain and store refueling consumption habit information.

Clause 22. The method of clause 21, wherein a probe device is further deployed in the gas station, and the method further comprises:
identifying, by using the probe device, identifier information of a terminal device associated with a user that enters the gas station for refueling;
determining associated user account information according to the identifier of the terminal device, and obtaining refueling consumption habit information of the user by using the user account information; and
pushing data object recommendation information to the user according to the refueling consumption habit information and a data object list associated with the gas station.

Clause 23. The method of clause 15, further comprising:
conducting statistics on population distribution information and/or vehicle feature information of the same gas station according to transaction orders associated with an identifier of the same gas station, to determine or adjust a data object structure in a store associated with the gas station.

Clause 24. A data processing method for a gas station, comprising:
obtaining, by an oil machine system, identifier information of a vehicle that enters the gas station for refueling from an image acquisition subsystem; and
determining resource information to be paid for refueling, and then providing the identified identifier information of the vehicle and the resource information to a service terminal of a network account subsystem, so that the service terminal of the network account subsystem determines associated user payment account information according to the identifier information of the vehicle and generates a refueling transaction order based on the resource information to be paid.

Clause 25. The method of clause 24, further comprising:
obtaining information about oil product as well as quantity required for refueling from the service terminal of the network account subsystem.

Clause 26. The method of clause 25, wherein a display screen is further deployed in the gas station, and the method further comprises:
outputting the required information about oil product as well as quantity obtained from the service terminal of the network account subsystem to the display screen deployed in the gas station for display.

Clause 27. The method of clause 25, wherein the gas station further comprises a mechanical arm for refueling, the mechanical arm being provided with a controller, and the method further comprises:
outputting the required information about oil product as well as quantity obtained from the service terminal of the network account subsystem to the controller of the mechanical arm, so that the controller of the mechanical arm controls the mechanical arm to complete a refueling process.

Clause 28. The method of clause 27, further comprising:
providing position and opening manner information of a fuel tank cap obtained from the service terminal of the network account subsystem to the controller of the mechanical arm, so that the controller generates a corresponding operation instruction and the mechanical arm completes operations to position and open the fuel tank cap.

Clause 29. An information processing method for a gas station, comprising:
providing in a user interface, by a client terminal of a network account subsystem, an operation option for configuring vehicle identifier information, required oil product information, and required refueling quantity information; and
submitting specific configuration information received through the operation option to a service terminal of the network account subsystem, so that the service terminal stores the specific configuration information and provides the specific configuration information to an oil machine subsystem when a vehicle enters the gas station for refueling.

Clause 30. The method of clause 29, further comprising:
providing an operation option for configuring position information and opening manner information of a fuel tank cap of the vehicle; and
submitting specific configuration information about the fuel tank cap received through the operation option to the service terminal of the network account subsystem, so that the service terminal stores the specific configuration information and provides the specific configuration information to the oil machine subsystem when the vehicle enters the gas station for refueling, and the oil machine subsystem provides the specific configuration information of the fuel tank cap to a controller of a mechanical arm of an oil machine.

Clause 31. The method of clause 30, further comprising:
providing multiple optional pieces of position information and multiple optional opening manners of fuel tank caps according to pre-generated standard description information of positions and opening manners, so that a specific piece of position information and a specific opening manner are selected therefrom to facilitate the controller of the mechanical arm to generate a control instruction.

Clause 32. A gas station system, comprising:
an image acquisition subsystem configured to acquire an image of a vehicle that enters the gas station and identify a vehicle identifier of the vehicle; and
an oil machine subsystem configured to obtain resource information to be paid for refueling and provide information of the identified vehicle identifier and the resource information to a service terminal of a network account subsystem, so that the service terminal of the network account subsystem determines associated user payment account information according to the information of the vehicle identifier and generates a refueling transaction order based on the resource information to be paid.

Clause 33. A data processing apparatus for a gas station, applied to a service terminal of a network account subsystem, comprising:
a graphic code information providing unit configured to provide a client terminal with information of a graphic code carrying user payment account information, so that the graphic code is displayed to a code scanning subsystem through the client terminal; and a transaction order generation unit configured to generate a transaction order after receiving resource information to be paid for refueling provided by the code scanning subsystem and payment account information which is submitted by the code scanning subsystem through scanning the graphic code.

Clause 34. A data processing apparatus for a gas station, applied to a code scanning subsystem, comprising:
a resource information receiving unit configured to receive resource information to be paid for refueling provided by an oil machine subsystem;
a graphic code scanning unit configured to scan a graphic code displayed by a client terminal of a network account subsystem, the graphic code carrying user payment account information; and
a submitting unit configured to provide a service terminal of the network account subsystem with the code scanning result and the resource information to be paid, so that the service terminal of the network account subsystem generates a transaction order.

Clause 35. A data processing apparatus for a gas station, applied to an oil machine subsystem, comprising:
a resource information providing unit configured to obtain resource information to be paid for refueling and provide the resource information to a code scanning subsystem;
a payment confirmation unit configured to request to obtain payment confirmation information from a service terminal of a network account subsystem after receiving a code scanning completion notification message provided by the code scanning subsystem, wherein a service terminal of the code scanning subsystem is configured to scan a graphic code carrying user payment account information that is provided by a client terminal of the network account subsystem, and provide the service terminal of the network account subsystem with the resource information to be paid, so that the service terminal of the network account subsystem generates a transaction order; and
a payment information transfer unit configured to provide payment success information to the code scanning subsystem after obtaining the payment success information from the service terminal of the network account subsystem.

Clause 36. A data processing apparatus for a gas station, applied to a service terminal of a network account subsystem, comprising:
an association relation providing unit configured to provide an association relation between user payment account information and vehicle identifier information;
an information receiving unit configured to receive identifier information of a vehicle that enters the gas station for refueling and resource information to be paid that are submitted by an oil machine subsystem; and
an order generation unit configured to determine associated payment account information according to the vehicle identifier information, and generate a transaction order according to the payment account information and the resource information.

Clause 37. A data processing apparatus for a gas station, applied to an oil machine subsystem, comprising:
a vehicle identifier information obtaining unit configured to obtain identifier information of a vehicle that enters the gas station for refueling from an image acquisition subsystem; and
an information submitting unit configured to determine resource information to be paid for refueling, and then provide the identified identifier information of the vehicle and the resource information to a service terminal of a network account subsystem, so that the service terminal of the network account subsystem determines associated user payment account information according to the identifier information of the vehicle and generates a refueling transaction order based on the resource information to be paid.

Clause 38. An information processing apparatus for a gas station, applied to a client terminal of a network account subsystem, comprising:
an operation option providing unit configured to provide, in a user interface, an operation option for configuring vehicle identifier information, required oil product information, and required refueling quantity information; and
a configuration information submitting unit configured to submit specific configuration information received through the operation option to a service terminal of the network account subsystem, so that the service terminal stores the specific configuration information and provides the specific configuration information to an oil machine subsystem when a vehicle enters the gas station for refueling.

Clause 39. A state information processing method for a gas station, comprising:
obtaining, by a service terminal of a network account subsystem, identifier information of vehicles that go into and out of the gas station from an oil machine subsystem of the gas station; and
conducting statistics on entering and leaving information of vehicles associated with the same gas station to obtain real-time busy or idle state information of the gas station.

Clause 40. A method for providing gas station information in an electronic map system, comprising:
receiving, by a client terminal of the electronic map system, a gas station search request; submitting the request to a service terminal of the electronic map system, so that the service terminal searches for a matched gas station according to geographical location information of a terminal device associated with the client terminal, and obtains real-time busy or idle state information of the matched gas station from a service terminal of a network account subsystem; and
providing, in an electronic map information interface, location information of the matched gas station on the map and the real-time busy or idle state information of the matched gas station according to a response returned by the service terminal.

Clause 41. A method for providing gas station information in an electronic map system, comprising:
receiving, by a service terminal of the electronic map system, a gas station search request from a client terminal;
searching for a matched gas station according to geographical location information of a terminal device associated with the client terminal, and obtaining real-time busy or idle state information of the matched gas station from a network account subsystem; and
returning location information of the matched gas station on the map and the real-time busy or idle state information of the matched gas station to the client terminal, so that the client terminal provides the location information and the real-time busy or idle state information in an electronic map information interface.

Clause 42. An information processing method for a gas station, comprising:
conducting statistics, by a service terminal of a network account subsystem, on gas-station-related transaction orders from a user dimension;
obtaining information about gas-station-related consumption habits of the same user; and
storing information about gas-station-related consumption habits of each user.

Clause 43. A method for pushing gas-station-related recommendation information, comprising:
obtaining, by an oil machine subsystem, identity information related to a user that enters a gas station for refueling;
obtaining information about gas-station-related consumption habits of the corresponding user from a service terminal of a network account subsystem by using the identity information related to the user; and
determining to-be-recommended data object information according to the information about gas-station-related consumption habits of the user and data object information associated with the gas station, and pushing the to-be-recommended data object information to the user.

Clause 44. A method for conducting statistics on information of a gas station, comprising:
conducting statistics, by a service terminal of a network account subsystem, on transaction orders related to gas stations from a gas station dimension;
obtaining user population distribution information associated with the same gas station; and
providing the user population distribution information to an oil machine subsystem, so that a data object structure of a store associated with the gas station is determined or adjusted according to the user population distribution information.

What is claimed is:

1. A system comprising:
a service terminal of a network account subsystem that provides an association relation between user payment account information and vehicle identifier information;
an image acquisition subsystem that acquires an image of a vehicle that enters a gas station for refueling, and identifies vehicle identifier information according to an image acquisition result; and
an oil machine subsystem that obtains resource information to be paid for refueling and provides the identified vehicle identifier information and the resource information to the service terminal of the network account subsystem, obtains information about oil product and quantity required for refueling, and outputs the required information about the oil product and the quantity to a controller of a mechanical arm to control the mechanical arm to complete a refueling process for the vehicle.

2. The system of claim 1, wherein the service terminal of the network account subsystem further determines associated user payment account information according to the vehicle identifier information and generates a refueling transaction order based on the resource information to be paid.

3. A method comprising:
providing an association relation between user payment account information and vehicle identifier information;
receiving identifier information of a vehicle that enters a gas station for refueling and resource information to be paid that are submitted by an oil machine subsystem;
determining associated payment account information according to the identifier information of the vehicle; and
generating a transaction order according to the payment account information and the resource information.

4. The method of claim 3, further comprising:
providing information about oil product as well as quantity required by the vehicle.

5. The method of claim 3, further comprising:
providing position and opening manner information of a fuel tank cap of the vehicle.

6. The method of claim 3, further comprising:
determining real-time busy or idle state information of the gas station according to identifier information of multiple vehicles that enter the gas station and states of the multiple vehicles; and
providing the real-time busy or idle state information of the gas station at an electronic map.

7. The method of claim 6, further comprising:
providing the electronic map with promotion manner information of the gas station.

8. The method of claim 6, further comprising:
providing the electronic map with an operation entry for recharging a refueling card.

9. The method of claim 3, further comprising:
conducting statistics on transaction orders that are associated with a user and related to consumption in gas stations; and
obtaining and storing refueling consumption habit information of the user.

10. The method of claim 9, further comprising:
identifying identifier information of a terminal device associated with a user of the vehicle;
determining associated user account information according to the identifier of the terminal device;
obtaining refueling consumption habit information of the user by using the user account information; and
pushing data object recommendation information to the user according to the refueling consumption habit information and a data object list associated with the gas station.

11. The method of claim 10, wherein the identifying the identifier information of the terminal device includes using a probe device to detect a unique identifier of the terminal device.

12. The method of claim 11, wherein the unique identifier of the terminal device includes a MAC address of the terminal device.

13. The method of claim 3, further comprising:
conducting statistics on population distribution information or vehicle feature information of the gas station according to transaction orders associated with the gas station to determine or adjust a data object structure in a store associated with the gas station.

14. A method comprising:
obtaining identifier information of a vehicle that enters a gas station for refueling from scanning an image of the vehicle;
determining resource information to be paid for refueling;
providing the identified identifier information of the vehicle and the resource information to a service terminal to determine associated user payment account information according to the identifier information of the vehicle and generate a refueling transaction order based on the resource information to be paid.

15. The method of claim 14, further comprising obtaining information about oil product and quantity required for refueling.

16. The method of claim 15, further comprising outputting the required information about the oil product and the quantity to a display screen for display.

17. The method of claim 16, further comprising:
outputting the required information about the oil product and the quantity obtained to a controller of a mechanical arm to control the mechanical arm to complete a refueling process.

18. The method of claim 17, further comprising:
providing position and opening manner information of a fuel tank cap to the controller of the mechanical arm, so that the controller generates a corresponding operation instruction to the mechanical arm and the mechanical arm completes operations to position and open the fuel tank cap.

19. The method of claim 14, further comprising:
obtaining identity information related to a terminal device of a user of the vehicle;
obtaining information about gas-station-related consumption habits of the user;
determining to-be-recommended data object information according to the information about the gas-station-related consumption habits of the user and data object information associated with the gas station; and
pushing the to-be-recommended data object information to the user.

20. The method of claim 19, further comprising:
conducting statistics on transaction orders related to gas stations from a gas station dimension;
obtaining user population distribution information associated with the gas station; and
providing the user population distribution information, so that a data object structure of a store associated with the gas station is determined or adjusted according to the user population distribution information.
